(19) United States
(12) Patent Application Publication
(10) Pub. No.: US 2026/0246511 A1
(43) Pub. Date: Aug. 20, 2026

(54) ANALOG BEAMFORMING WEIGHT LEARNING WITH DISCRETE ANTENNAS

(71) Applicant: QUALCOMM Incorporated, San Diego, CA (US)

(72) Inventors: Vasanthan RAGHAVAN, West Windsor Township, NJ (US); Yu ZHANG, San Diego, CA (US); Juergen CEZANNE, Ocean Township, NJ (US); Junyi LI, Greentown, PA (US)

(21) Appl. No.: 19/058,504

(22) Filed: Feb. 20, 2025

(51) Int. Cl. H04B 7/06; H04L 5/00; H04W 8/22

(52) U.S. Cl. CPC H04B 7/0617; H04L 5/0051; H04W 8/22

(57) ABSTRACT

Various aspects of the present disclosure generally relate to wireless communication. In some aspects, a user equipment (UE) may communicate, with a network node, information associated with an analog beamforming procedure for generating one or more sets of analog beamforming weights for communications via a frequency range using a set of monopole antennas. The UE may generate the one or more sets of analog beamforming weights in accordance with communicating the information associated with the analog beamforming procedure. The UE may communicate, with the network node via the frequency range using the set of monopole antennas, one or more messages according to the one or more sets of analog beamforming weights. Numerous other aspects are described.

### FIELD OF THE DISCLOSURE

Aspects of the present disclosure generally relate to wireless communication and specifically relate to techniques, apparatuses, and methods associated with analog beamforming weight learning with discrete antennas.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Beamforming is a technique in which a wireless communications device, such as a user equipment, uses an array of antenna elements to transmit radio signals in a specific beam direction or receive radio signals from a specific beam direction. Analog beamforming (ABF) may involve the use of phase shifters or amplitude control to co-phase antenna elements at a radio frequency or in an analog domain to form a specific beam. For example, multiple antenna elements may be combined at the radio frequency using ABF weights. ABF weights may correspond to the use of phase shifter or amplitude control for co-phasing multiple antenna elements over each layer.

### SUMMARY

Some aspects described herein relate to a user equipment (UE). The UE may include a processing system. The processing system may include one or more processors and one or more code-storing memories coupled with the one or more processors. The processing system may be configured to cause the UE to communicate, with a network node, information associated with an analog beamforming (ABF) procedure for generating one or more sets of ABF weights for communications via a frequency range using a set of monopole antennas. The processing system may be configured to cause the UE to generate the one or more sets of ABF weights in accordance with communicating the information associated with the ABF procedure. The processing system may be configured to cause the UE to communicate, with the network node via the frequency range using the set of monopole antennas, one or more messages according to the one or more sets of ABF weights.

Some aspects described herein relate to a network node. The network node may include a processing system. The processing system may include one or more processors and one or more code-storing memories coupled with the one or more processors. The processing system may be configured to cause the network node to communicate, with a UE that is using a set of monopole antennas, information associated with an ABF procedure for generating one or more sets of ABF weights to be used for communications via a frequency range associated with the set of monopole antennas. The processing system may be configured to cause the network node to communicate, with the UE via the frequency range, one or more messages in accordance with the ABF procedure.

Some aspects described herein relate to a method of wireless communications performed by a UE. The method may include communicating, with a network node, information associated with an ABF procedure for generating one or more sets of ABF weights for communications via a frequency range using a set of monopole antennas. The method may include generating the one or more sets of ABF weights in accordance with communicating the information associated with the ABF procedure. The method may include communicating, with the network node via the frequency range using the set of monopole antennas, one or more messages according to the one or more sets of ABF weights.

Some aspects described herein relate to a method of wireless communication performed by a network node. The method may include communicating, with a UE that is using a set of monopole antennas, information associated with an ABF procedure for generating one or more sets of ABF weights to be used for communications via a frequency range associated with the set of monopole antennas. The method may include communicating, with the UE via the frequency range, one or more messages in accordance with the ABF procedure.

Some aspects described herein relate to a non-transitory computer-readable medium that stores a set of instructions for wireless communication by a UE. The set of instructions, when executed by one or more processors of the UE, may cause the UE to communicate, with a network node, information associated with an ABF procedure for generating one or more sets of ABF weights for communications via a frequency range using a set of monopole antennas. The set of instructions, when executed by one or more processors of the UE, may cause the UE to generate the one or more sets of ABF weights in accordance with communicating the information associated with the ABF procedure. The set of instructions, when executed by one or more processors of the UE, may cause the UE to communicate, with the network node via the frequency range using the set of monopole antennas, one or more messages according to the one or more sets of ABF weights.

Some aspects described herein relate to a non-transitory computer-readable medium that stores a set of instructions for wireless communication by a network node. The set of instructions, when executed by one or more processors of the network node, may cause the network node to communicate, with a UE that is using a set of monopole antennas, information associated with an ABF procedure for generating one or more sets of ABF weights to be used for communications via a frequency range associated with the set of monopole antennas. The set of instructions, when executed by one or more processors of the network node, may cause the network node to communicate, with the UE via the frequency range, one or more messages in accordance with the ABF procedure.

Some aspects described herein relate to an apparatus for wireless communication. The apparatus may include means for communicating, with a network node, information associated with an ABF procedure for generating one or more sets of ABF weights for communications via a frequency range using a set of monopole antennas. The apparatus may include means for generating the one or more sets of ABF weights in accordance with communicating the information associated with the ABF procedure. The apparatus may include means for communicating, with the network node via the frequency range using the set of monopole antennas, one or more messages according to the one or more sets of ABF weights.

Some aspects described herein relate to an apparatus for wireless communication. The apparatus may include means for communicating, with a UE that is using a set of monopole antennas, information associated with an ABF procedure for generating one or more sets of ABF weights to be used for communications via a frequency range associated with the set of monopole antennas. The apparatus may include means for communicating, with the UE via the frequency range, one or more messages in accordance with the ABF procedure.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of antenna ports.

FIG. 4 is a diagram illustrating two examples of forming a virtual antenna port by combining non-coherent or partially-coherent antenna ports.

FIG. 5 is a diagram illustrating an example beamforming architecture that supports beamforming for millimeter wave (mmW) communications.

FIG. 6 is a diagram illustrating an example of a discrete antenna configuration.

FIG. 7A is a diagram illustrating a first example of a procedure for analog beamforming (ABF) beam weight learning.

FIG. 7B is a diagram illustrating a second example of a procedure for ABF beam weight learning.

FIG. 8 is a diagram of an example associated with ABF beam weight learning with discrete antennas.

FIG. 9 is a diagram illustrating an example of a procedure for ABF beam weight learning.

FIG. 10 is a diagram illustrating an example of a resource configuration.

FIG. 11 is a diagram illustrating an example process performed, for example, at a UE or an apparatus of a UE.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

Analog beamforming (ABF) may involve the use of phase shifters or amplitude control to co-phase antenna elements at a radio frequency (RF) or in an analog domain. ABF may typically be used in frequency range two (FR2) frequencies for improving a link budget of an mmWave system that is impaired with blockage/penetration or an increased path loss. FR2 may range from 24.25 gigahertz (GHz) to 52.6 GHz. An FR2 based antenna system may include one or more antenna modules, or one or more antenna panels. An antenna module may include a dual polarized phased antenna array. The antenna module may be associated with an antenna array, such as a 5×1 antenna array (e.g., five antenna elements in the antenna array).

ABF may be typically used in FR2/mmWave frequencies for improving link budget of mmWave systems that are affected by increased blockage, penetration loss, or path loss. For example, antennas may be a priori grouped across polarizations in an antenna module design.

ABF may not be implemented in some frequency ranges (FRs) (e.g., FR1, FR3) and extending ABF to these other frequency ranges may be associated with various challenges. The discrete antennas may communicate over one polarization (e.g., only one polarization) due to a lack of sufficient space for dual-polarized systems. Planar inverted F antennas (e.g., instead of patch antennas may be used for communications via some FRs (e.g., FR1/FR3). Planar inverted F antennas may include small, flat antennas that may be used in wireless communication devices like phones, tablets, and laptops. Planar inverted F antennas are a type of inverted-F antenna (IFA) that are designed to operate at microwave and UHF frequencies, in some examples. These antennas may be designed as dual-polarized antennas but may take up more area and may not support wideband applications. A discrete antenna may be a single polarized antenna (e.g., monopole antenna) that is implemented within a user equipment (UE) frame or housing. However, the grouping of antennas that may be co-phased may consume significant time and overhead resources. ABF may include learning and applying weights or weighting factors to one or more aspects of a radio signal, such as phase or power, or both, to form a specific communication beam. For example, ABF weights may be applied to the analog signals at the radio frequency level, controlling the phase and amplitude of signals from multiple antennas to steer the communication beam, rather than at the baseband level like in digital beamforming

In some wireless communications systems, a UE may not indicate a reference signal configuration or reference signal information to a network node for ABF beam weight learning. For example, when a downlink data channel (e.g., physical downlink data channel) is configured with reference signals (e.g., demodulation reference signals (DMRSs)), the reference signals and the downlink data channel may be configured by the network node to be communicated during a same time resource across different frequency resources of the time resource. As a result, there may be a time lag associated with the UE learning ABF beam weights from the reference signal and using the weights to communicate the downlink data channel. Additionally, in some examples, once the ABF beam weights have been learned, the UE may program the ABF weights to the RF hardware of the UE, which may cause additional delay.

Current FR1 and FR3 wireless communications systems may lack information signaling to support these time delays.

Various aspects relate generally to ABF beam weight learning using discrete antennas. Some aspects more specifically relate to ABF beam weight learning using discrete antennas in FR1 or FR3 wireless communications systems. In some aspects, a UE and a network node may communicate information associated with an ABF procedure for generating one or more sets of ABF weights for communications via a frequency range (e.g., FR1, FR2, FR3) using a set of monopole antennas (e.g., discrete antennas). In some aspects, the UE may generate one or more sets of ABF weights based on communicating the ABF information. The UE and the network node may communicate with each other using one or more antennas, or antenna modules, with the ABF weights applied.

In some aspects, the UE may transmit, and the network node may receive, a time duration indication that indicates a duration of time between the UE measuring a wireless communications channel (e.g., between the UE and the network node) and generating the one or more sets of ABF weights. In some aspects, the UE may transmit, and the network node may receive, an indication of one or more subsequent messages to be communicated using the one or more sets of ABF weights. In some aspects, the UE may receive, and the network node may transmit, a reference signal configuration that indicates at least one of a first type of reference signal or a second type of reference signal.

Particular aspects of the subject matter described in this disclosure can be implemented to realize one or more of the following potential advantages. In some examples, the described techniques can be used to increase coverage and network capacity. By communicating the ABF information, the UE and the network node may experience enhanced coordination while an ABF procedure is being performed, which may support an increased quality of communications in scenarios with increased blockage, penetration losses, or path losses. By communicating the time duration indication, the network node may transit a reference signal configuration that accommodates the amount of time used by the UE to generate ABF weights, apply the ABF weights, or both. By communicating the indication of one or more subsequent messages, the UE and the network node may conserve overhead by reusing ABF weights for subsequent communications instead of performing an additional ABF procedure. By communicating the reference signal configuration that indicates at least one of a first type of reference signal, or a second type of reference signal, the UE and the network node may experience increased flexibility and may select scenarios in which to implement ABF, which may conserve resources for scenarios in which the benefits of ABF are minimal.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

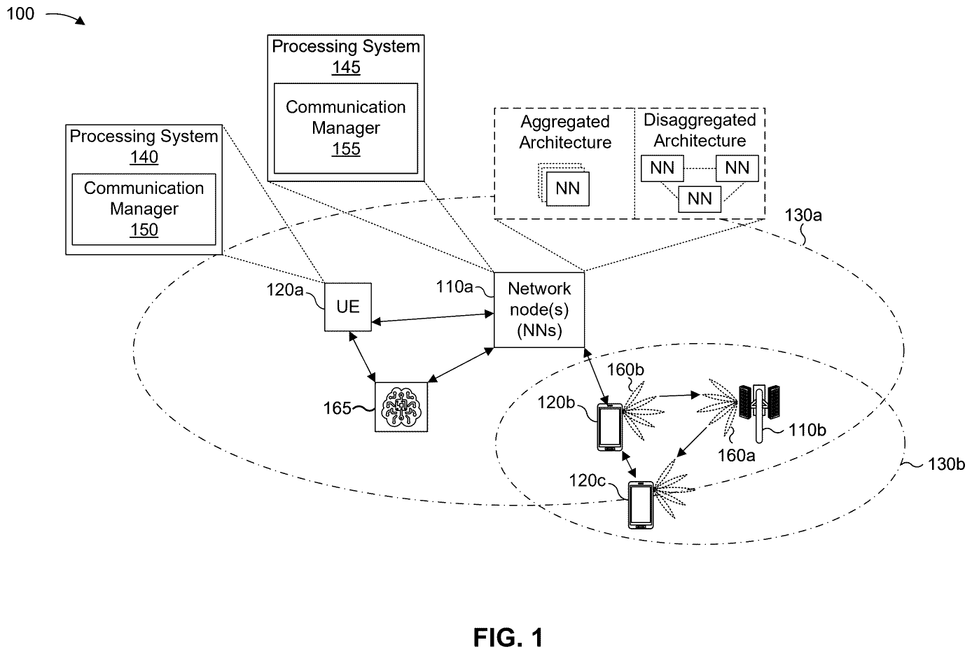

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

An antenna panel, an antenna group, or an antenna array may include one or more antenna elements (within a single housing or multiple housings), one or more coplanar antenna elements, one or more non-coplanar antenna elements, or one or more antenna elements coupled with one or more transmission or reception components, such as the processing system 140 or the processing system 145. “Antenna element” refers to single radiating (for example, transmitting) or receiving point included in an antenna array. An antenna array may also be referred to as a “sub-array.” An antenna array may include one or more antenna elements where each antenna element is configured as a single unit for radiating (for example, transmitting) or receiving one or more RF signals. In some examples, each of the antenna elements of an antenna may include one or more sub-elements for radiating or transmitting or receiving RF signals. A “sub-element” refers to an individual component (e.g., an individually controllable component) within an antenna element, such as an individual radiating unit. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively or destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers or phases of the signal(s) to form one or more beams. The shape of a beam (such as the amplitude, width, or presence of side lobes) or the direction of a beam (such as an angle of the beam relative to a surface of an antenna array) can be dynamically controlled by modifying the phase shifts, phase offsets, or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Advantages of using a larger number of antenna elements may include providing increased control over parameters for beam generation relative to a smaller number of antenna elements, whereas advantages of using a smaller number of antenna elements may include reducing implementation complexity, or reduced power consumption compared to use of a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Advancements in antenna designs may be driven by the need for faster data rates, lower latency, or more reliable connectivity in advanced/next-generation systems, such as 6G systems, massive multiple-input multiple-output (massive MIMO) systems, among other examples. For example, the wireless communication network 100 may operate using higher frequency bands, such as millimeter wave frequencies or terahertz (THz) frequencies, which enable faster data transmissions and increased bandwidth. To enable UEs 120 and network nodes 110 to communicate using these higher frequency bands, antennas (or antenna elements) of the UEs 120 and network nodes 110 may be configured to address the increased signal attenuation or limited range associated with these higher frequency bands. For example, a UE 120 or a network node 110 may use advanced beamforming techniques, such as AI/ML-based beamforming techniques (for example, in which an AI/ML model can be used to dynamically adjust beamforming patterns in response to changing network conditions, channel conditions, or UE location, among other examples, to improve signal strength or reduce interference). Additionally, the antennas may have a higher density of antenna elements (e.g., as compared to conventional antenna configurations) to enable more precise beam steering or to increase the quantity of independent beams that can be formed simultaneously using an antenna panel (thereby supporting an increased quantity of simultaneous connections). Additionally, the wireless communication network 100 may include one or more devices that have dynamically configurable antenna panels or antenna elements (for example, for an intelligent reflecting surface (IRS) or a reconfigurable intelligent surface (RIS)) to improve coverage and signal strength.

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam (for example, a beam having a larger angular spread) to communicate with the UE 120 when the UE 120 is in motion or for initial beam acquisition because wider coverage may increase the likelihood that the UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some examples, a UE 120 or a network node 110 may use an inference model (for example, an AI/ML model) to obtain one or more inferences or predictions for beamforming. An output of the inference model may include a codebook based spatial domain selection or prediction (for example, that indicates one or more predicted measurement values for one or more beams) or a non-codebook based spatial domain selection or prediction (for example, that indicates one or more parameters for a beam, such as a point-direction, an angle of departure (AoD), or an angle of arrival (AoA), among other examples). The UE 120 or the network node 110 may configure one or more antenna elements to form one or more beams in accordance with the output of the inference model.

In some aspects, the UE 120 may include a communication manager 150. As described in more detail elsewhere herein, the communication manager 150 may communicate, with a network node, information associated with an ABF procedure for generating one or more sets of ABF weights for communications via a frequency range using a set of monopole antennas; generate the one or more sets of ABF weights in accordance with communicating the information associated with the ABF procedure; and communicate, with the network node via the frequency range using the set of monopole antennas, one or more messages according to the one or more sets of ABF weights. Additionally, or alternatively, the communication manager 150 may perform one or more other operations described herein.

In some aspects, the network node 110 may include a communication manager 155. As described in more detail elsewhere herein, the communication manager 155 may communicate, with a UE that is using a set of monopole antennas, information associated with an ABF procedure for generating one or more sets of ABF weights to be used for communications via a frequency range associated with the set of monopole antennas; and communicate, with the UE via the frequency range, one or more messages in accordance with the ABF procedure. Additionally, or alternatively, the communication manager 155 may perform one or more other operations described herein.

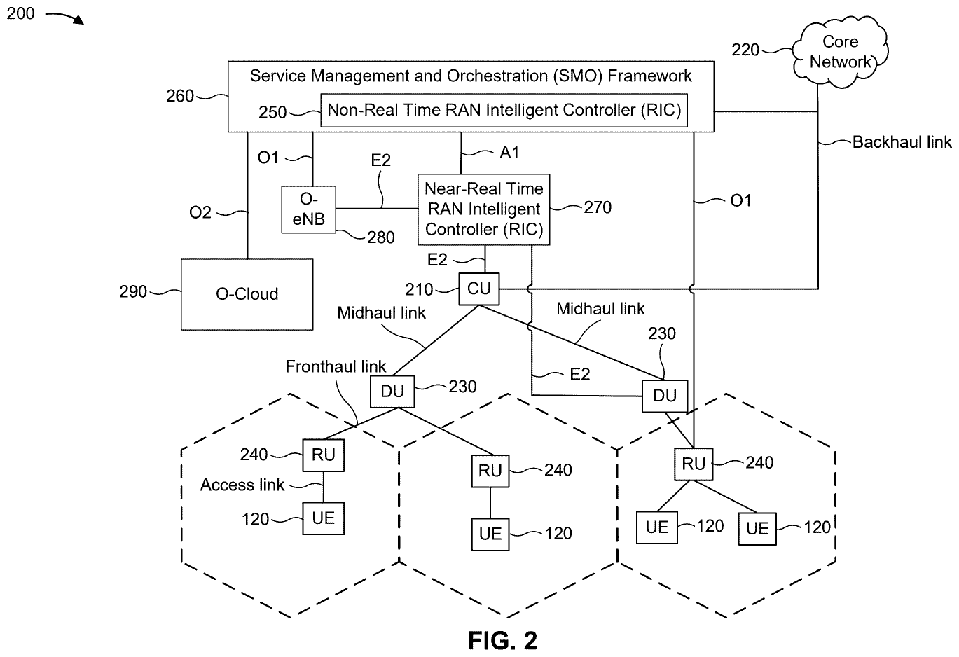

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

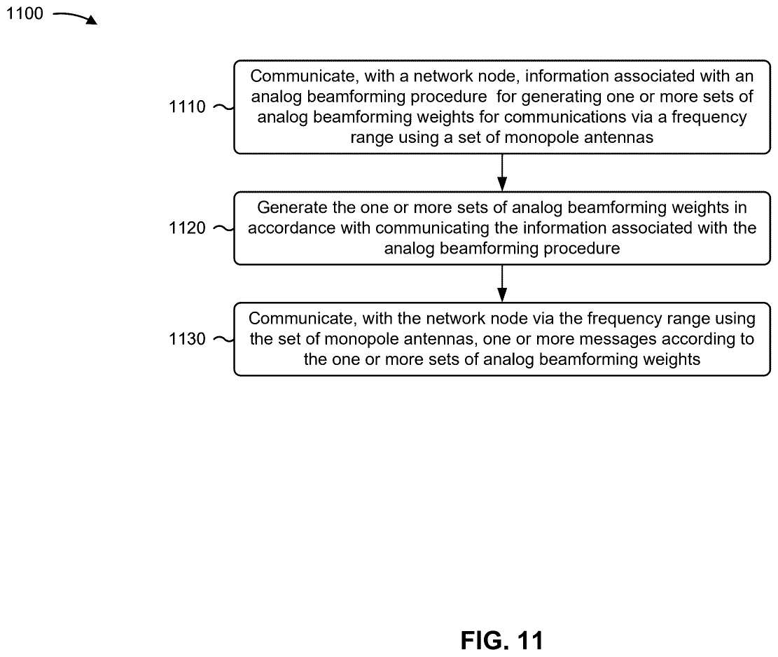

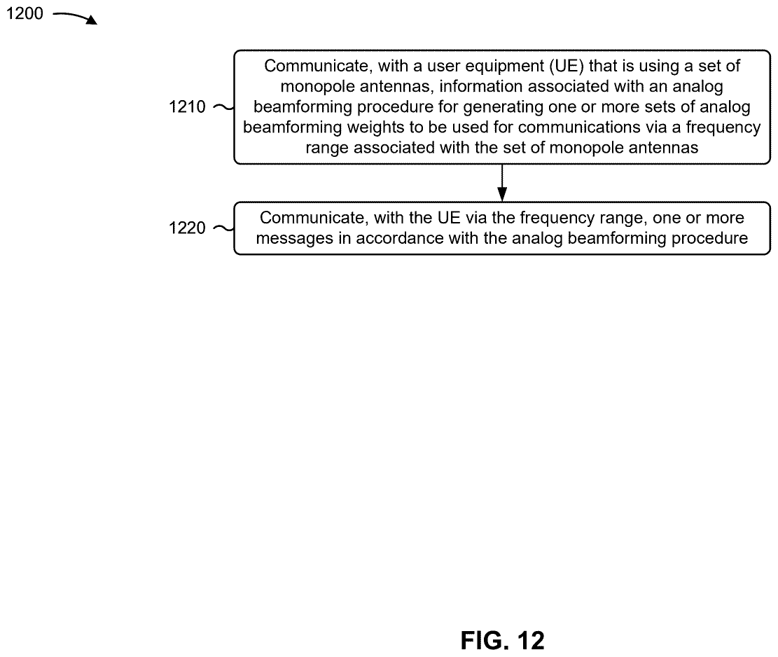

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with ABF beam weight learning with discrete antennas, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

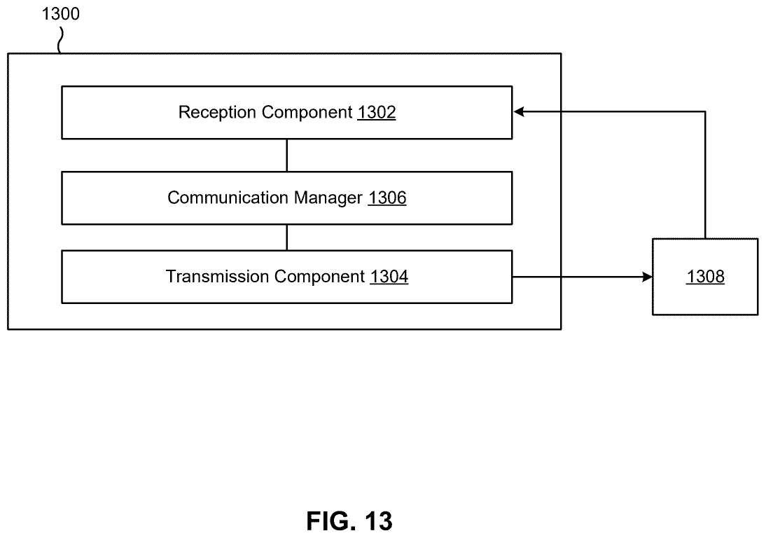

In some aspects, the UE 120 includes means for communicating, with a network node, information associated with an ABF procedure for generating one or more sets of ABF weights for communications via a frequency range using a set of monopole antennas; means for generating the one or more sets of ABF weights in accordance with communicating the information associated with the ABF procedure; or means for communicating, with the network node via the frequency range using the set of monopole antennas, one or more messages according to the one or more sets of ABF weights. The means for the UE to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

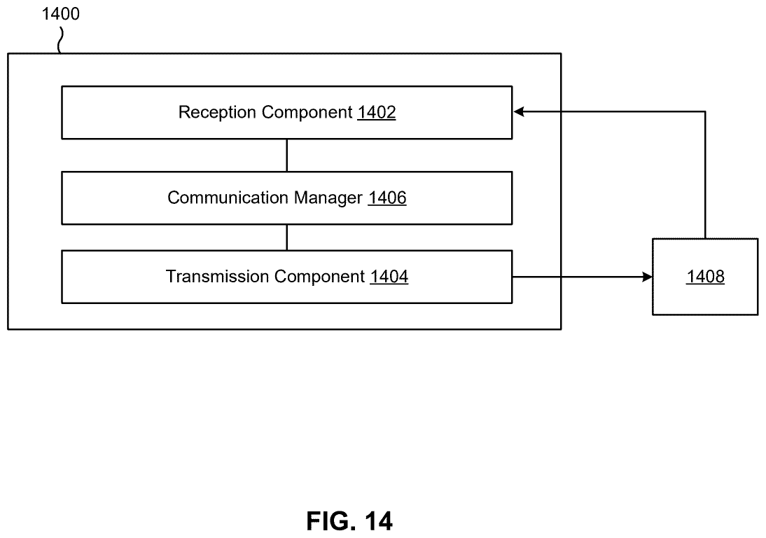

In some aspects, the network node includes means for communicating, with a UE that is using a set of monopole antennas, information associated with an ABF procedure for generating one or more sets of ABF weights to be used for communications via a frequency range associated with the set of monopole antennas; or means for communicating, with the UE via the frequency range, one or more messages in accordance with the ABF procedure. The means for the network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

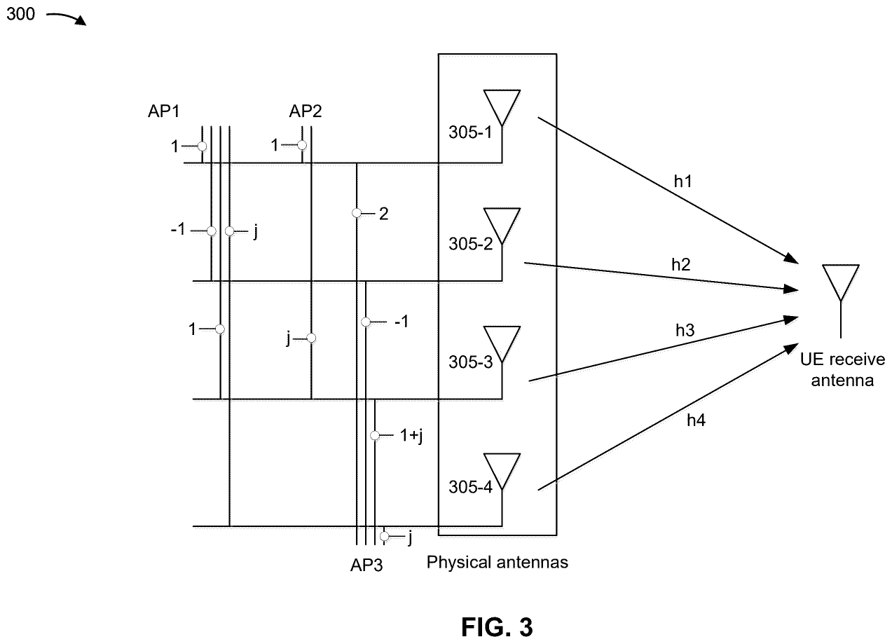

FIG. 3 is a diagram illustrating an example 300 of antenna ports.

As shown in FIG. 3, a first physical antenna 305-1 may transmit information via a first channel h1, a second physical antenna 305-2 may transmit information via a second channel h2, a third physical antenna 305-3 may transmit information via a third channel h3, and a fourth physical antenna 305-4 may transmit information via a fourth channel h4. Such information may be conveyed via a logical antenna port, which may represent some combination of the physical antennas or channels. In some cases, a UE 120 may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 300, a channel associated with antenna port 1 (AP1) is represented as h1−h2+h3+j*h4, where channel coefficients (e.g., 1, −1, 1, and j, in this case) represent weighting factors (e.g., indicating phase or gain) applied to each channel. Such weighting factors may be applied to the channels to improve signal power or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

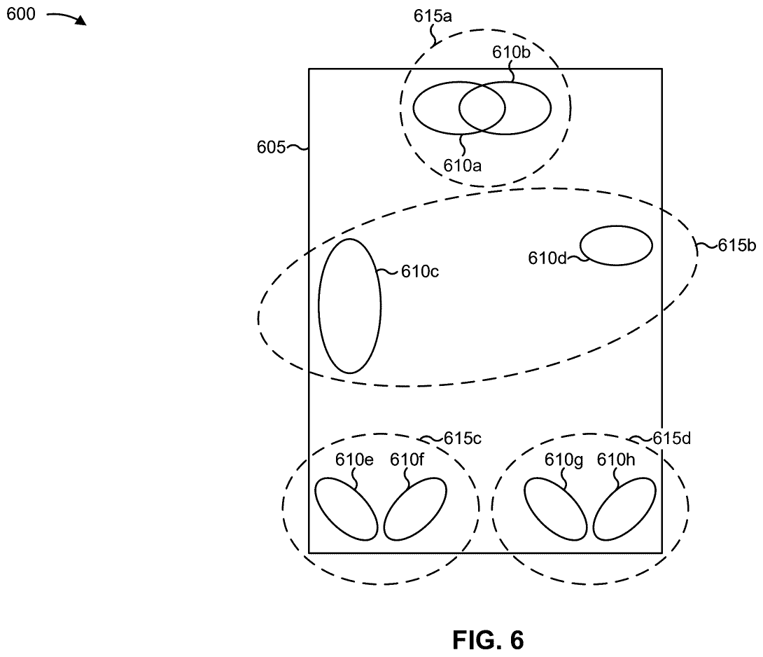

In some examples, antennas 305 may be combined to create a virtual module (e.g., a static pairing of discrete antennas), described in further detail with respect to FIG. 6. In some examples, the antennas 305 may include monopole antennas, omnidirectional antennas, quasi-omnidirectional antennas, planar inverted F antennas, discrete antennas, unipolarized antennas, patch antennas, dipole antennas, or any combination thereof (e.g., omni-directional monopole antennas, quasi-omnidirectional monopole antennas), or may include any combination of other types of antennas arranged in a linear pattern, a two-dimensional pattern, or another pattern within a single housing or multiple housings.

As indicated above, FIG. 3 is provided merely as an example. Other examples may differ from what is described with regard to FIG. 3.

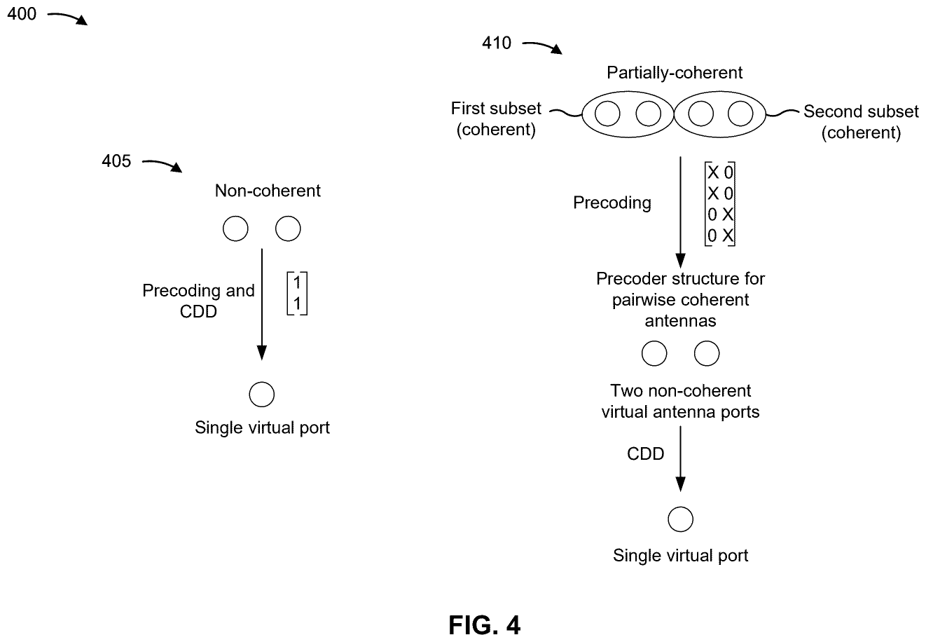

FIG. 4 is a diagram illustrating two examples 400 of forming a virtual antenna port by combining non-coherent or partially-coherent antenna ports.

The antennas of a multi-antenna wireless communication device such as a UE (e.g., UE 120) may be classified into one of three groups depending on coherence of the antenna ports of the UE. A set of antenna ports (for example, two antenna ports) are coherent if the relative phase among the set of antenna ports (for example, between the two antenna ports) remains the same between the time of an SRS transmission from those antenna ports and a subsequent physical uplink shared channel (PUSCH) transmission from those antenna ports. In this case, the SRS may be used (for example, by the UE or a network node) to determine an uplink precoder for precoding the PUSCH transmission, because the relative phase of the antenna ports will be the same for the SRS transmission and the PUSCH transmission. The precoding may span across the set of coherent antenna ports.

If a set of antenna ports is non-coherent, then such uplink precoder determination becomes difficult, because the relative phase between the antenna ports will change from the SRS transmission to the PUSCH transmission. For example, a set of antenna ports is considered non-coherent if the relative phase among the set of antenna ports is different for the SRS transmission than for the PUSCH transmission. In this case, the use of the same uplink precoder for a set of non-coherent antenna ports may result in the UE applying improper or inaccurate precoding weights (such as phase and gain weights) to the data streams transmitted from the non-coherent antenna ports. Furthermore, a set of antenna ports is considered partially-coherent if a first subset of the set of antenna ports is coherent with one another and a second subset of the set of antenna ports is coherent with one another, but the first subset of antenna ports and the second subset of antenna ports are not coherent with one another. In this case, common precoding may be used within each of the respective subsets of coherent antenna ports, but not across the different subsets of non-coherent antenna ports.

In some cases, when a network node schedules a PUSCH transmission for a multi-antenna UE having non-coherent or partially-coherent antenna ports, the signaling communication that schedules the PUSCH transmission may identify an uplink precoder that is to be used to precode the PUSCH transmission. Conventionally, because the antenna ports of the UE are non-coherent (or, in the case of partially coherent antenna ports, are non-coherent groups of coherent antenna ports), the UE may be capable of using the uplink precoder for only one of the antenna ports (or antenna port groups) while other antenna ports (or antenna port groups) are not used for the PUSCH transmission. Because only a subset of non-coherent or partially coherent antenna ports are used, this may result in decreased transmit power of the PUSCH transmission, decreased reliability of the PUSCH transmission (due to lack of transmit or spatial diversity), or the like.

To utilize some or all of the non-coherent or partially coherent antenna ports, the UE may apply various techniques to synthesize non-coherent or partially coherent antenna ports into a virtual antenna port so that common precoding may be used on the virtual antenna port and applied across the non-coherent antenna ports. A virtual (or logical) antenna port may represent a combination of two or more antenna ports. This allows a network node to select an uplink precoder for the virtual antenna port, and allows the UE to use the uplink precoder to transmit on the otherwise non-coherent or partially coherent antenna ports that have been combined to form the virtual antenna port.

For example, as shown by reference number 405, a set of non-coherent antenna ports (e.g., shown as two non-coherent antenna ports) can be combined into a single virtual port using precoding (e.g., uplink precoding) and cyclic delay diversity. The precoder may be determined by the UE 120 or signaled by a network node 110. Cyclic delay diversity (CDD) may refer to a technique where a delay (e.g., a cyclic delay) is introduced on one of the non-coherent antenna ports and not the other non-coherent antenna port. In some examples, the delay may be measured in samples (e.g., 5 samples, 10 samples, or another quantity of samples) or fractions of samples. For example, a first non-coherent antenna port may transmit a first stream of samples, and the second non-coherent antenna port may transmit a second stream of samples (e.g., which may be the same stream) with a slight cyclic delay (e.g., a delay of 5 samples, 10 samples, or another quantity of samples). For example, for a cyclic delay of 5 samples, where 16 samples are transmitted per symbol, the first non-coherent antenna port may transmit the 16 samples with a first sample transmitted first (e.g., [s1, s2, s3, s4, . . . , s16]), and the second non-coherent antenna port may transmit the 16 samples with the first sample transmitted sixth (e.g., with a delay of five samples) (e.g., [s12, s13, s14, s15, s16, s1, s2, s3, . . . , s11]).

Additionally, or alternatively, as shown by reference number 410, a set of partially-coherent antenna ports can be combined into a single virtual antenna port using precoding (e.g., uplink precoding) and cyclic delay diversity, in a similar manner as described above. As shown, a first subset of antenna ports may be coherent with one another, and a second subset of antenna ports may be coherent with one another, but the two subsets may not be coherent with one another. As further shown, precoding may be applied to the individual subsets to generate a first virtual antenna port and a second virtual antenna port that are not coherent with one another. Then, CDD may be applied to these two virtual antenna ports (e.g., by transmitting communications from the virtual antenna ports using CDD), thereby forming a single virtual antenna port from the partially-coherent antenna ports (e.g., using precoding and CDD).

Although FIG. 4 shows pairs of antenna ports in sets and subsets, in some aspects, a different number of antenna ports may be included in a set or a subset. For example, a set of antenna ports or subset of antenna ports may include three antenna ports, four antenna ports, or another quantity of antenna ports.

To improve the link margin on DL/UL, multiple antenna elements may be combined at RF using ABF weights. ABF beam weights may correspond to the use of a phase shifter and/or amplitude control for co-phasing multiple antenna elements over each layer. A quantity of layers or antenna elements combined in ABF per layer may be determined by a UE based on implementation (e.g., according to performance improvement objectives, complexity of ABF weight searching in terms of antenna combination, searching of beam weights to be used, etc.). Some aspects described herein may include procedures in which ABF beam weights may be learned for virtual module construction.

As indicated above, FIG. 4 is provided as one or more examples. Other examples may differ from what is described with regard to FIG. 4.

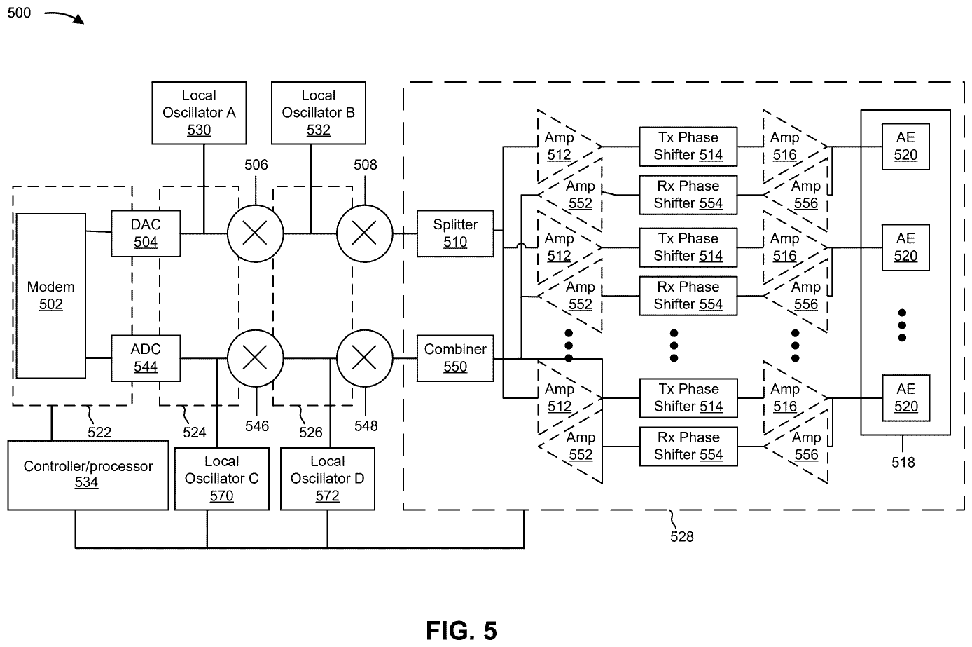

FIG. 5 is a diagram illustrating an example beamforming architecture 500 that supports beamforming for millimeter wave (mmW) communications. In some aspects, architecture 500 may implement aspects of wireless network 100. In some aspects, architecture 500 may be implemented in a transmitting device (e.g., a first wireless communication device, UE, or network node) or a receiving device (e.g., a second wireless communication device, UE, or network node), as described herein.

Broadly, FIG. 5 is a diagram illustrating example hardware components of a wireless communication device in accordance with certain aspects of the disclosure. The illustrated components may include those that may be used for antenna element selection or for beamforming for transmission of wireless signals. There are numerous architectures for antenna element selection and implementing phase shifting, only one example of which is illustrated here. The architecture 500 includes a modem (modulator/demodulator) 502, a digital to analog converter (DAC) 504, a first mixer 506, a second mixer 508, and a splitter 510. The architecture 500 also includes multiple first amplifiers 512, multiple phase shifters 514, multiple second amplifiers 516, and an antenna array 518 that includes multiple antenna elements 520.

Transmission lines or other waveguides, wires, or traces are shown connecting the various components to illustrate how signals to be transmitted may travel between components. Reference numbers 522, 524, 526, and 528 indicate regions in the architecture 500 in which different types of signals travel or are processed. Specifically, reference number 522 indicates a region in which digital baseband signals travel or are processed, reference number 524 indicates a region in which analog baseband signals travel or are processed, reference number 526 indicates a region in which analog intermediate frequency (IF) signals travel or are processed, and reference number 528 indicates a region in which analog radio frequency (RF) signals travel or are processed. The architecture also includes a local oscillator A 530, a local oscillator B 532, and a controller/processor 534. In some aspects, controller/processor 534 corresponds to controller/processor 240 of the network node 110 described above in connection with FIG. 2 or controller/processor 280 of the UE 120 described above in connection with FIG. 2.

Each of the antenna elements 520 may include one or more sub-elements for radiating or receiving RF signals. For example, a single antenna element 520 may include a first sub-element cross-polarized with a second sub-element that can be used to independently transmit cross-polarized signals. The antenna elements 520 may include patch antennas, dipole antennas, or other types of antennas arranged in a linear pattern, a two dimensional pattern, or another pattern. A spacing between antenna elements 520 may be such that signals with a desired wavelength transmitted separately by the antenna elements 520 may interact or interfere (e.g., to form a desired beam). For example, given an expected range of wavelengths or frequencies, the spacing may provide a quarter wavelength, half wavelength, or other fraction of a wavelength of spacing between neighboring antenna elements 520 to allow for interaction or interference of signals transmitted by the separate antenna elements 520 within that expected range.

The modem 502 processes and generates digital baseband signals and may also control operation of the DAC 504, first and second mixers 506, 508, splitter 510, first amplifiers 512, phase shifters 514, or the second amplifiers 516 to transmit signals via one or more or all of the antenna elements 520. The modem 502 may process signals and control operation in accordance with a communication standard such as a wireless standard discussed herein. The DAC 504 may convert digital baseband signals received from the modem 502 (and that are to be transmitted) into analog baseband signals. The first mixer 506 upconverts analog baseband signals to analog IF signals within an IF using a local oscillator A 530. For example, the first mixer 506 may mix the signals with an oscillating signal generated by the local oscillator A 530 to “move” the baseband analog signals to the IF. In some cases, some processing or filtering (not shown) may take place at the IF. The second mixer 508 upconverts the analog IF signals to analog RF signals using the local oscillator B 532. Similar to the first mixer, the second mixer 508 may mix the signals with an oscillating signal generated by the local oscillator B 532 to “move” the IF analog signals to the RF or the frequency at which signals will be transmitted or received. The modem 502 or the controller/processor 534 may adjust the frequency of local oscillator A 530 or the local oscillator B 532 so that a desired IF or RF frequency is produced and used to facilitate processing and transmission of a signal within a desired bandwidth.

In the illustrated architecture 500, signals upconverted by the second mixer 508 are split or duplicated into multiple signals by the splitter 510. The splitter 510 in architecture 500 splits the RF signal into multiple identical or nearly identical RF signals. In other examples, the split may take place with any type of signal, including with baseband digital, baseband analog, or IF analog signals. Each of these signals may correspond to an antenna element 520, and the signal travels through and is processed by amplifiers 512, 516, phase shifters 514, or other elements corresponding to the respective antenna element 520 to be provided to and transmitted by the corresponding antenna element 520 of the antenna array 518. In one example, the splitter 510 may be an active splitter that is connected to a power supply and provides some gain so that RF signals exiting the splitter 510 are at a power level equal to or greater than the signal entering the splitter 510. In another example, the splitter 510 is a passive splitter that is not connected to power supply and the RF signals exiting the splitter 510 may be at a power level lower than the RF signal entering the splitter 510.

After being split by the splitter 510, the resulting RF signals may enter an amplifier, such as a first amplifier 512, or a phase shifter 514 corresponding to an antenna element 520. The first and second amplifiers 512, 516 are illustrated with dashed lines because one or both of them might not be necessary in some aspects. In some aspects, both the first amplifier 512 and second amplifier 516 are present. In some aspects, neither the first amplifier 512 nor the second amplifier 516 is present. In some aspects, one of the two amplifiers 512, 516 is present but not the other. By way of example, if the splitter 510 is an active splitter, the first amplifier 512 may not be used. By way of further example, if the phase shifter 514 is an active phase shifter that can provide a gain, the second amplifier 516 might not be used.

The amplifiers 512, 516 may provide a desired level of positive or negative gain. A positive gain (positive dB) may be used to increase an amplitude of a signal for radiation by a specific antenna element 520. A negative gain (negative dB) may be used to decrease an amplitude or suppress radiation of the signal by a specific antenna element. Each of the amplifiers 512, 516 may be controlled independently (e.g., by the modem 502 or the controller/processor 534) to provide independent control of the gain for each antenna element 520. For example, the modem 502 or the controller/processor 534 may have at least one control line connected to each of the splitter 510, first amplifiers 512, phase shifters 514, or second amplifiers 516 that may be used to configure a gain to provide a desired amount of gain for each component and thus each antenna element 520.

The phase shifter 514 may provide a configurable phase shift or phase offset to a corresponding RF signal to be transmitted. The phase shifter 514 may be a passive phase shifter not directly connected to a power supply. Passive phase shifters might introduce some insertion loss. The second amplifier 516 may boost the signal to compensate for the insertion loss. The phase shifter 514 may be an active phase shifter connected to a power supply such that the active phase shifter provides some amount of gain or prevents insertion loss. The settings of each of the phase shifters 514 are independent, meaning that each can be independently set to provide a desired amount of phase shift or the same amount of phase shift or some other configuration. The modem 502 or the controller/processor 534 may have at least one control line connected to each of the phase shifters 514 and which may be used to configure the phase shifters 514 to provide a desired amount of phase shift or phase offset between antenna elements 520.

In the illustrated architecture 500, RF signals received by the antenna elements 520 are provided to one or more first amplifiers 556 to boost the signal strength. The first amplifiers 556 may be connected to the same antenna arrays 518 (e.g., for time division duplex (TDD) operations). The first amplifiers 556 may be connected to different antenna arrays 518. The boosted RF signal is input into one or more phase shifters 554 to provide a configurable phase shift or phase offset for the corresponding received RF signal to enable reception via one or more Rx beams. The phase shifter 554 may be an active phase shifter or a passive phase shifter. The settings of the phase shifters 554 are independent, meaning that each can be independently set to provide a desired amount of phase shift or the same amount of phase shift or some other configuration. The modem 502 or the controller/processor 534 may have at least one control line connected to each of the phase shifters 554 and which may be used to configure the phase shifters 554 to provide a desired amount of phase shift or phase offset between antenna elements 520 to enable reception via one or more Rx beams.

The outputs of the phase shifters 554 may be input to one or more second amplifiers 552 for signal amplification of the phase shifted received RF signals. The second amplifiers 552 may be individually configured to provide a configured amount of gain. The second amplifiers 552 may be individually configured to provide an amount of gain to ensure that the signals input to combiner 550 have the same magnitude. The amplifiers 552 or 556 are illustrated in dashed lines because they might not be necessary in some aspects. In some aspects, both the amplifier 552 and the amplifier 556 are present. In another aspect, neither the amplifier 552 nor the amplifier 556 are present. In other aspects, one of the amplifiers 552, 556 is present but not the other.

In the illustrated architecture 500, signals output by the phase shifters 554 (via the amplifiers 552 when present) are combined in combiner 550. The combiner 550 in architecture 500 combines the RF signal into a signal. The combiner 550 may be a passive combiner (e.g., not connected to a power source), which may result in some insertion loss. The combiner 550 may be an active combiner (e.g., connected to a power source), which may result in some signal gain. When combiner 550 is an active combiner, it may provide a different (e.g., configurable) amount of gain for each input signal so that the input signals have the same magnitude when they are combined. When combiner 550 is an active combiner, the combiner 550 may not need the second amplifier 552 because the active combiner may provide the signal amplification.

The output of the combiner 550 is input into mixers 548 and 546. Mixers 548 and 546 generally down convert the received RF signal using inputs from local oscillators 572 and 570, respectively, to create intermediate or baseband signals that carry the encoded and modulated information. The output of the mixers 548 and 546 are input into an analog-to-digital converter (ADC) 544 for conversion to digital signals. The digital signals output from ADC 544 are input to modem 502 for baseband processing, such as decoding, de-interleaving, or similar operations.

The architecture 500 is given by way of example only to illustrate an architecture for transmitting or receiving signals. In some cases, the architecture 500 or each portion of the architecture 500 may be repeated multiple times within an architecture to accommodate or provide an arbitrary number of RF chains, antenna elements, or antenna panels. Furthermore, numerous alternate architectures may be used. For example, although only a single antenna array 518 is shown, two, three, or more antenna arrays may be included, each with one or more of their own corresponding amplifiers, phase shifters, splitters, mixers, DACs, ADCs, or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 522, 524, 526, 528) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 510, amplifiers 512, 516, or phase shifters 514 may be located between the DAC 504 and the first mixer 506 or between the first mixer 506 and the second mixer 508. In one example, the functions of one or more of the components may be combined into one component. For example, the phase shifters 514 may perform amplification to include or replace the first or or second amplifiers 512, 516. By way of another example, a phase shift may be implemented by the second mixer 508 to obviate the need for a separate phase shifter 514. This technique is sometimes called local oscillator (LO) phase shifting. In some aspects of this configuration, there may be multiple IF to RF mixers (e.g., for each antenna element chain) within the second mixer 508, and the local oscillator B 532 may supply different local oscillator signals (with different phase offsets) to each IF to RF mixer.

The modem 502 or the controller/processor 534 may control one or more of the other components 504 through 572 to select one or more antenna elements 520 or to form beams for transmission of one or more signals. For example, the antenna elements 520 may be individually selected or deselected for transmission of a signal (or signals) by controlling an amplitude of one or more corresponding amplifiers, such as the first amplifiers 512 or the second amplifiers 516. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 520, the radiated signals interact, interfere (constructive and destructive interference), and amplify each other to form a resulting beam. The shape (such as the amplitude, width, or presence of side lobes) and the direction (such as an angle of the beam relative to a surface of the antenna array 518) can be dynamically controlled by modifying the phase shifts or phase offsets imparted by the phase shifters 514 and amplitudes imparted by the amplifiers 512, 516 of the multiple signals relative to each other. The controller/processor 534 may be located partially or fully within one or more other components of the architecture 500. For example, the controller/processor 534 may be located within the modem 502 in some aspects.

ABF may not be implemented in some frequency ranges (e.g., FR1, FR3) according to some wireless communications standards and extending ABF to these other frequency ranges may be associated with various challenges. The discrete antennas 610 may communicate over one polarization due to a lack of sufficient space for dual-polarized systems. Planar inverted F array antennas may be used for communications via some FRs (e.g., FR1/FR3). These antennas may be designed as dual-polarized antenna but may take up more area and may not support wideband applications. A discrete antenna 610 may be a single polarized antenna (e.g., monopole antenna) that is implemented within a UE frame or housing. However, the grouping of antennas that may be co-phased may consume significant time and overhead resources.

As indicated above, FIG. 5 is provided as an example. Other examples may differ from what is described with regard to FIG. 5.

FIG. 6 is a diagram illustrating an example 600 of a discrete antenna configuration. Example 600 include an antenna panel 605 (e.g., an antenna panel described in connection with FIG. 1), which may be or include an antenna group, an antenna array, an antenna sub-array. A UE (e.g., UE 120 described in connection with FIG. 1) may include or house the antenna panel 605. The antenna panel 605 may include one or more antenna elements 610 (e.g., antenna elements described in connection with FIG. 1) (within a single housing or multiple housings), including antenna elements 610a-610h, which may be or include one or more coplanar antenna elements, one or more non-coplanar antenna elements, or one or more antenna elements coupled with one or more transmission or reception components, such as the processing system 140 or the processing system 145, described in connection with FIG. 1. While the example 600 illustrates that the antenna array 605 includes 8 antenna elements 610, the antenna array 605 may include any quantity of antenna elements, N, and the techniques described herein may be applicable to a same or similar degree. Each antenna element 610 may be configured as a single unit for radiating (for example, transmitting) or receiving, one or more RF signals carrying a communication (e.g., data or control information or both). In some examples, each of the antenna elements 610 may include one or more sub-elements for radiating (or transmitting) or receiving RF signals. The antenna elements 610 may include monopole antennas, omnidirectional antennas, quasi-omnidirectional antennas, planar inverted F antennas, discrete antennas, unipolarized antennas, patch antennas, dipole antennas, or any combination thereof (e.g., omni-directional monopole antennas, quasi-omnidirectional monopole antennas), or may include any combination of other types of antennas arranged in a linear pattern, a two-dimensional pattern, or another pattern within a single housing or multiple housings. A spacing between antenna elements 610 may be such that signals with a desired wavelength transmitted separately by the antenna elements 610 may interact or interfere constructively or destructively along various directions to form a specific communication beam. In some examples, antenna elements 610 may be individually selected or deselected for directional transmission of a signal (or signals) by controlling amplitudes of one or more corresponding amplifiers or phases of the signal(s) to form one or more beams or virtual modules 615. The direction, amplitude, width, or presence of side lobes of a beam associated with a virtual module 615 may be dynamically controlled by modifying the phase shifts, phase offsets, or amplitudes of the multiple signals relative to each other.

The antenna elements 610 may be configured for communications in some frequency ranges, such as FR1, or FR3, or both, described in connection with FIG. 1. For example, the antenna elements 610 may communicate via a 3.8 GHz frequency as well as 7-8 GHz and 13 GHz frequencies. In some examples, multiple antenna elements 610 may be combined for communications at a particular RF using ABF weights. ABF may include the use of phase shifters or amplitude control to co-phase the antenna elements 610 at a radio frequency of interest. ABF may be typically used in FR2/mmWave frequencies for improving link budgets of mmWave systems that are impaired with increased blockage, penetration loss, or path loss, among other examples.

For example, the antenna elements 610 may be a priori grouped across polarizations in an antenna module design (e.g., a design of the antenna panel 605). ABF weights may include or correspond to the use of phase shifters or amplitude control for co-phasing multiple antenna elements 610 over each layer associated with communications at the UE. A quantity of layers, or a quantity of antenna elements combined using ABF weights per layer, or both, may be determined by the UE according to UE implementation. For example, the UE may select, calculate, or identify the quantity of layers, or quantity of antenna elements per layer, based on performance metrics (e.g., such as a requisite performance improvement or threshold), or complexity of a beam searching procedure (e.g., beamforming search, antenna combination search, beamforming weight search), among other examples.

In the example 600, ABF may be used to form the virtual modules 615. For example, a first set of one or more ABF weights may be applied to the antenna element 610a, or the antenna element 610b, or both, to form the virtual module 615a; a second set of one or more ABF weights may be applied to the antenna element 610b, or the antenna element 610c, or both, to form the virtual module 615b; a third set of one or more ABF weights may be applied to the antenna element 610e, or the antenna element 610f, or both, to form the virtual module 615c; and a fourth set of one or more ABF weights may be applied to the antenna element 610g, or the antenna element 610h, or both, to form the virtual module 615d.

In some wireless communications system, a UE may not indicate a reference signal configuration or reference signal information to a network node for ABF beam weight learning. For example, when a downlink data channel (e.g., physical downlink data channel) is configured with reference signals (e.g., demodulation reference signals (DMRSs)), the reference signals and the downlink data channel may be configured by the network node to be communicated during a same time resource across different frequency resources of the time resource. As a result, there may be a time lag associated with the UE learning ABF beam weights from the reference signal and using the weights to communicate the downlink data channel. Additionally, in some examples, once the ABF beam weights have been learned, the UE may program the ABF weights to the RF hardware of the UE, which may cause additional delay

As indicated above, FIG. 6 is provided as an example. Other examples may differ from what is described with respect to FIG. 6.

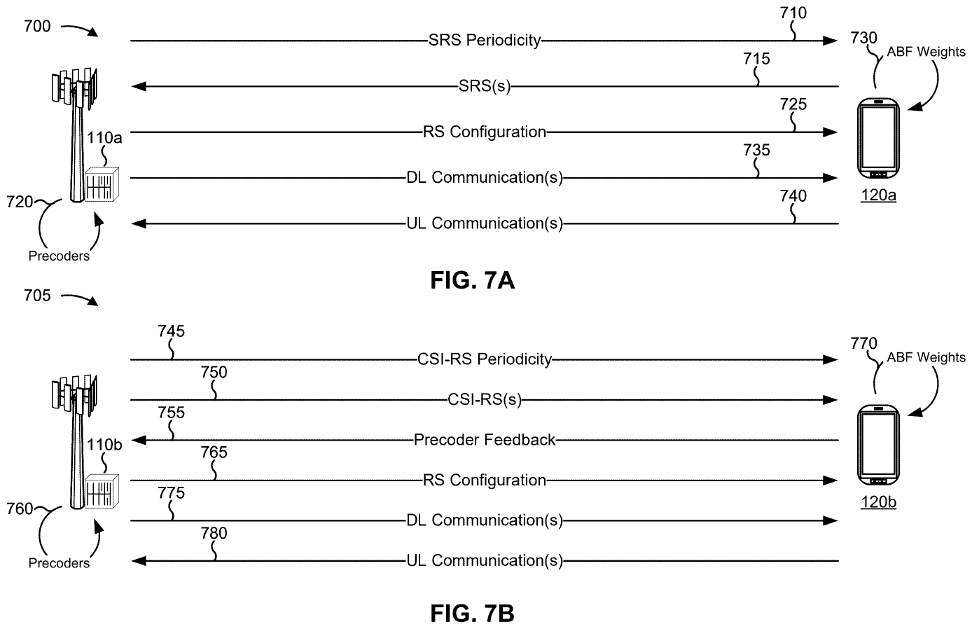

FIG. 7A is a diagram illustrating a first example 700 of a procedure for ABF beam weight learning. As shown in FIG. 7A, a network node 110a and a UE 120a may communicate with one another.

As shown by reference number 710, the network node 110a may transmit, and the UE 120a may receive, an SRS periodicity indication. The network node 110a may configure (or, for example, may transmit a configuration of) an SRS periodicity based on network node-UE channel dynamics (e.g., conditions, qualities, characteristics), or pathloss, or both. In some examples, configuring the SRS periodicity based on network node-UE channel dynamics or pathloss may result in more accurate or useful precoders, or ABF weights, or both, especially for scenarios in which the UE 120a is within the cell supported by the network node 110a and is relatively close to the network node 110a, or is located in a middle region of the cell.

As shown by reference number 715, the UE 120a may transmit, and the network node 110a may receive, one or more SRS transmissions. In some examples, the UE 120a may transmit the one or more SRS transmissions using previously-obtained ABF weights, or using no ABF weights.

As shown by reference number 720, the network node 110a may identify, calculate, or otherwise determine, one or more precoders. The network node 110a may learn the one or more precoders in association with receiving the one or more SRS transmissions. For example, the network node 110a may select or derive a precoder based on, or otherwise associated with, measuring the one or more uplink transmissions, as described in connection with FIGS. 1, 3, and 4.

As shown by reference number 725, the network node 110a may transmit, and the UE 120a may receive, a reference signal configuration. For example, the network node 110a may configure or transmit a configuration for communicating one or more reference signals.

As shown by reference number 730, the UE 120a may identify, calculate, or otherwise determine uplink ABF weights, or downlink ABF weights, or both, in association with communicating the one or more reference signals according to the configuration.

As shown by reference number 735, the network node 110a may transmit, and the UE 120a may receive, using the identified ABF weights or independently from the identified ABF weights, one or more downlink communications.

As shown by reference number 740, the UE 120a may transmit, using the identified ABF weights or independently from the identified ABF weights, and the network node 110a may receive, one or more uplink communications.

FIG. 7B is a diagram illustrating a second example 705 of a procedure for ABF beam weight learning. As shown in FIG. 7B, a network node 110b and a UE 120b may communicate with one another.

As shown by reference number 745, the network node 110b may transmit, and the UE 120b may receive, a CSI-RS periodicity indication. The network node 110a may configure (or, for example, may transmit a configuration indicating) a CSI-RS periodicity based on network node-UE channel dynamics (e.g., conditions, qualities, characteristics), or pathloss, or both. In some examples, configuring the CSI-RS periodicity based on network node-UE channel dynamics or pathloss may result in more accurate or useful precoders, or ABF weights, or both, especially for scenarios in which the UE 120a is within the cell supported by the network node 110a and is relatively far from the network node 110a, or is located in an edge region of the cell.

As shown by reference number 750, the network node 110b may transmit, and the UE 120b may receive, one or more CSI-RS transmissions.

As shown by reference number 755, the UE 120b may transmit, and the network node 110b may receive, feedback in response to or based on receiving, or measuring, the one or more CSI-RS transmissions. The feedback may include information associated with one or more precoders for improving or maintaining communication quality between the network node 110b and the UE 120b.

As shown by reference number 760, the network node 110b may identify, calculate, or otherwise determine one or more precoders. The network node 110b may learn the one or more precoders in association with receiving the precoder feedback. For example, the network node 110b may select or derive a precoder based on, or otherwise associated with, the UE 120b measuring the one or more downlink transmissions and transmitting the feedback to the network node 110b.

As shown by reference number 765, the network node 110b may transmit, and the UE 120b may receive, a reference signal configuration. For example, the network node 110b may configure, or transmit a configuration for, communicating one or more reference signals.

As shown by reference number 770, the UE 120b may identify, calculate, or otherwise determine uplink ABF weights, or downlink ABF weights, or both, in association with communicating the one or more reference signals according to the configuration.

As shown by reference number 775, the network node 110b may transmit, and the UE 120b may receive, using the identified ABF weights or independently from the identified ABF weights, one or more downlink communications.

As shown by reference number 780, the UE 120b may transmit, using the identified ABF weights or independently from the identified ABF weights, and the network node 110b may receive, one or more uplink communications.

In the example 700, the UE 120a or UE 120b may not indicate a reference signal configuration or reference signal information to the network node 110a or network node 110b for ABF beam weight learning. For example, when a downlink data channel (e.g., physical downlink data channel) is configured with reference signals (e.g., DMRSs), the reference signals and the downlink data channel may be configured by the network node to be communicated during a same time resource across different frequency resources of the time resource. As a result, there may be a time lag associated with the UE 120 learning ABF beam weights from the reference signal and using the weights to communicate the downlink data channel. Additionally, in some examples, once the ABF beam weights have been learned, the UE 120 may program the ABF weights to the RF hardware of the UE 120, which may cause additional delay.

As indicated above, FIGS. 7A and 7B are provided as examples. Other examples may differ from what is described with respect to FIG. 7.

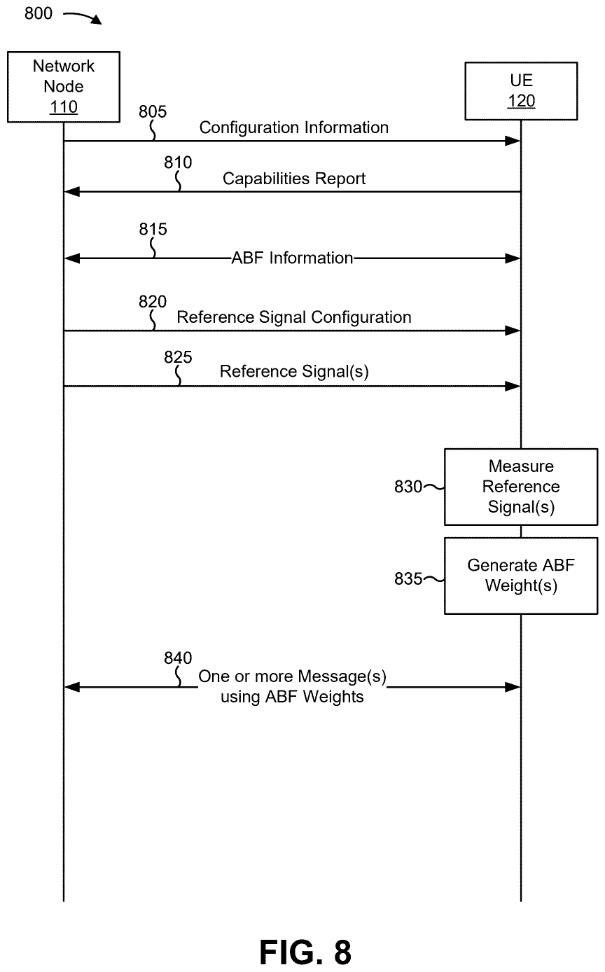

FIG. 8 is a diagram of an example 800 associated with ABF beam weight learning with discrete antennas. As shown in FIG. 8, a network node 110 (e.g., a base station, a CU, a DU, or an RU) may communicate with a UE 120. In some aspects, the network node 110 and the UE 120 may be part of a wireless network (e.g., the wireless communication network 100 described in connection with FIG. 1). The UE 120 and the network node 110 may have established a wireless connection prior to operations shown in FIG. 8.

In some aspects, as shown by reference number 805, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for ABF beam weight learning using one or more discrete antennas. As another example, the capability information may indicate a capability or parameter for ABF beam weight learning via one or more frequency ranges. As another example, the capability information may indicate a capability or parameter for a time offset or gap during which the UE 120 is capable of performing ABF beam weight learning via one or more frequency ranges. One or more operations described herein may be based on capability information. For example, the UE 120 may perform a communication in accordance with the capability information, or may receive configuration information that is in accordance with the capability information. In some aspects, the capability information may indicate UE support for programming ABF weights to RF hardware of the UE 120, or a duration for programming ABF weights to RF hardware of the UE 120.

As shown by reference number 810, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration selection or communication parameter selection from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to perform ABF beam weight learning using one or more reference signals. In some aspects, the configuration information may indicate a reference signal configuration which the UE 120 may use to perform ABF beam weight learning.

The UE 120 may configure itself based at least in part on the configuration information. In some aspects, the UE 120 may be configured to perform one or more operations described herein based at least in part on the configuration information.

As shown by reference number 815, the UE 120 and the network node 110 may communicate ABF information. For example, the UE 120 and the network node 110 may communicate information associated with an ABF procedure for generating one or more sets of ABF weights for communications via a frequency range using a set of monopole antennas. In some aspects, the frequency range includes at least one of FR1, FR2, or FR3.

In some aspects, communicating the information associated with the ABF weights may include the UE 120 transmitting, and the network node 110 receiving, a time duration indication that indicates a duration of time between measuring a wireless communications channel between the UE 120 and the network node 110 and generating the one or more sets of ABF weights. For example, to accommodate the time lag between the UE 120 taking reference signal measurements and the UE 120 generating the one or more set of ABF weights to use for communications during a time resource (e.g., a PUSCH/PDSCH symbol), the UE 120 may transmit an indication of the gap period to the network node 110. In some aspects, the duration of time may include a quantity of time resources between at least one of a first channel measurement or a last channel measurement, and a time resource during which the one or more sets of ABF weights are generated. In some aspects, the duration of time may be associated with at least one of a hardware capability or an RF capability of the UE 120. In some aspects, the time duration indication may be associated with the frequency range of the communications. For example, a time duration indication transmitted via some frequency ranges may be different from a time duration indication transmitted via other frequency ranges.

In some aspects, communicating the information associated with the ABF procedure may include the UE 120 transmitting, and the network node 110 receiving, a capability indication that indicates a duration of time in which the UE 120 is capable of generating the one or more sets of ABF weights. For example, the time gap may be based on UE capability (e.g., in terms of time used to dynamically generate the ABF weights such that the ABF weights at least partially converge on a stable corresponding value while being generated).

In some aspects, communicating the information associated with the ABF procedure may include the UE 120 transmitting a time duration indication associated with generating the one or more sets of ABF weights. In such aspects, the UE 120 may refrain from communicating with the network node 110 during a duration of time indicated by the time duration indication, or the network node 110 may refrain from transmitting, to the UE 120, during a duration of time indicated by the time duration indication, a resource grant in association with receiving the time duration indication, or both.

In some aspects, the UE 120 may transmit, and the network node 110 may receive, a channel feedback request associated with a trigger condition being satisfied. In such aspects, the UE 120 may receive, and the network node 110 may transmit, a reference signal indication indicating a reference signal type associated with the ABF procedure. In some aspects, the UE 120 may transmit, and the network node 110 may receive, an indication of a reference signal periodicity for generating the one or more sets of ABF weights. In such aspects, the reference signal periodicity may be associated with one or more channel conditions.

As shown by reference number 820, the network node 110 may transmit, and the UE 120 may receive, a reference signal configuration. For example, the network node 110 may transmit, and the UE 120 may receive, a reference signal configuration that indicates a set of one or more granted reference signals, a quantity of granted reference signals, or both. In some aspects, the quantity of granted reference signals may be associated with a capability of the UE 120. For example, a quantity of reference signals or a reference signal resource grant by the network node 110 may correspond to or be based on a UE capability. In some aspects, the quantity of granted reference signals may be associated with a quantity of active receive antenna chains in a set of active receive antenna chains associated with the UE, and a quantity of antenna elements, associated with the set of active receive antenna chains, that are combined to form one or more virtual modules. For example, the quantity of granted reference signals may be based on a dynamic UE capability in terms of how many RF chains are configured to be active at a given instance. In some aspects, the set of one or more granted reference signals may include at least one of a set of one or more CSI-RSs, or a set of one or more DMRSs. In some aspects, the reference signal configuration may indicate one or more time-frequency resources for communicating the set of one or more granted reference signals. In some aspects, the set of one or more granted reference signals includes one or more front-loaded (e.g., scheduled during an initial portion of a set of time resources) reference signals that are associated with a downlink control channel.

In some aspects, the UE 120 may receive, from the network node 110, a reference signal configuration that indicates at least one of a first type of reference signal or a second type of reference signal. In some such aspects, the first type of reference signal may include a reference signal that is independent of a time offset associated with generating the one or more sets of ABF weights. For example, for the first type of reference signal, RSs may be provided for measurements but with no gap/delay (e.g., may be granted during any time or on any symbol). In some other such aspects, the second type of reference signal may include a reference signal that is associated with generating the one or more sets of ABF weights. For example, for the second type of reference signal, the network node 110 may trigger or indicate to the UE 120 to use the RSs for measurements to determine ABF beam weights and to use the ABF weights with a subsequently indicated data symbol (e.g., which may be indicated after the UE-indicated time gap).

As shown by reference number 825, the network node 110 may transmit, and the UE 120 may receive, one or more reference signals. For example, the network node 110 may transmit, and the UE 120 may receive, one or more reference signals for measuring a wireless communications channel between the UE 120 and the network node 110. In some aspects, the UE 120 and the network node 110 may communicate, via a set of one or more frequency resources allocated to the UE 120, each reference signal indicated by the reference signal configuration independently from other communications via the set of one or more frequency resources allocated to the UE 120. For example, CSI-RSs may not be frequency division multiplexed with other reference signals or channels because the UE 120 may apply different ABF weights to receive the multiple CSI-RSs.

In some aspects, the network node 110 may transmit, and the UE 120 may receive, a set of one or more tracking reference signals. In such aspects, generating the one or more sets of ABF weights described in connection with reference number 835 may be associated with receiving the set of one or more tracking reference signals.

As shown by reference number 830, the UE 120 may measure the one or more reference signals. For example, the UE 120 may measure the one or more reference signals to obtain one or more channel measurements associated with the wireless communications channel.

In some aspects, the UE 120 may estimate a delay spread associated with a channel between the UE and the network node. In such aspects, the UE 120 may transmit, and the network node 110 may receive, an indication of a time associated with triggering an ABF procedure that includes generating the one or more sets of ABF weights. In some aspects, communicating the indication of the time associated with triggering an ABF procedure may be communicated as part of the ABF information described in connection with reference number 815 or may be communicated separately.

As shown by reference number 835, the UE 120 may generate one or more ABF weights. For example, the UE 120 may generate one or more sets of ABF weights in accordance with communicating the information associated with the ABF procedure, described in connection with reference number 815.

As shown by reference number 840, the UE 120 and the network node 110 may communicate one or more messages using the ABF weights. For example, the UE 120 and the network node 110 may communicate, via the frequency range using the set of monopole antennas, one or more messages according to the one or more sets of ABF weights.

In some aspects, the UE 120 may transmit an indication of one or more subsequent messages to be communicated using the one or more set of ABF weights. In such aspects, the UE 120 and the network node 110 may communicate the one or more subsequent messages according to the one or more sets of ABF weights, in accordance with the indication of the one or more subsequent messages.

As indicated above, FIG. 8 is provided as an example. Other examples may differ from what is described with respect to FIG. 8.

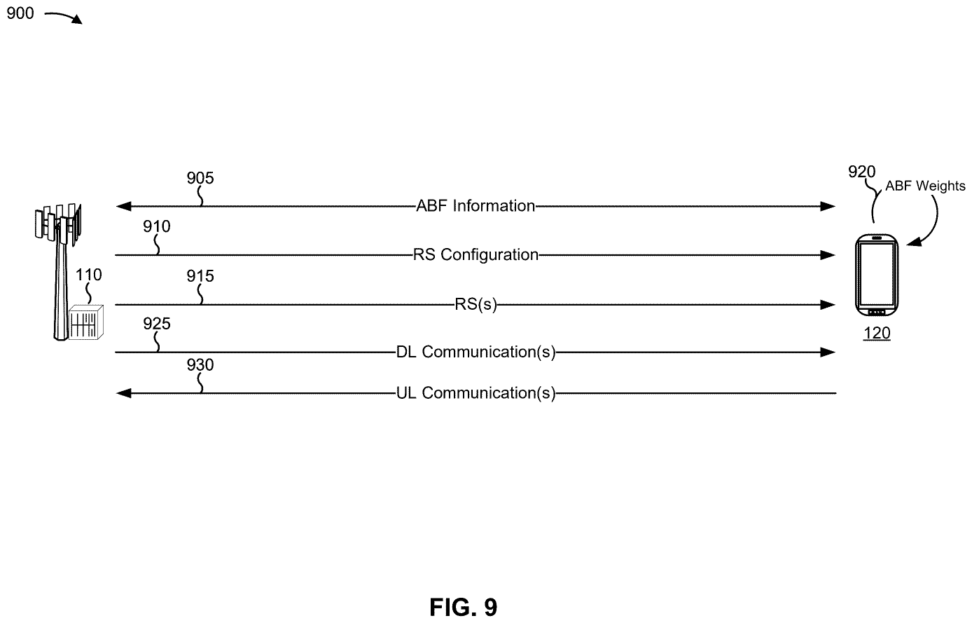

FIG. 9 is a diagram illustrating an example 900 of a procedure for ABF beam weight learning. As shown in FIG. 9, a network node 110 and a UE 120 may communicate with one another.

As shown by reference number 905, the UE 120 and the network node 110 may communicate ABF information. For example, to accommodate the time gap between making RS measurements and generating ABF beam weights for use with a data symbol, the UE 120 may indicate an amount of time (e.g., in the time gap period) to the network node 110. One example metric may include a symbol gap between a first or last RS used for measurements and the symbol via which ABF beam weights have stabilized (e.g., converged on a value that is statistically likely to remain the same in the presence of additional calculations). In some aspects, this indication may be specific to or newly defined for FR1 or FR3 communications. In some aspects, the gap period may be based on a UE capability. For example, the gap period may include a capability-based duration of time used for beamforming weights to settle down at a particular RF. In such aspects, the network node 110 may refrain from configuring or granting resources to the UE 120 during the time gap.

As shown by reference number 910, the network node 110 may configure and grants RSs, via an RS configuration, to the UE for reference signal measurement. In some aspects, the indicated RSs may be front-loaded DMRSs associated with a PDSCH. In some other aspects, the indicated RSs may be CSI-RSs. In some such aspects, CSI-RSs may not be frequency multiplexed with other RSs or channels because the UE 120 may apply different ABF beam weights to receive different CSI-RSs. In some aspects, the network node 110 may configure at least two types of RSs for measurements. For example, a first type of RSs may be provided for measurements without accommodating the gap or delay between the measurements and generating the ABF weights. A first type of RSs may include RSs to measure for ABF weight generation. For example, the network node 110 may transmit an indication to the UE 120 that triggers the UE 120 to use the RSs for measurements to determine ABF beam weights. In such aspects, the UE 120 may use the generated ABF weights with a subsequently indicated data symbol (e.g., PDSCH, PUSCH, occurring after the UE-indicated gap). The second type of reference signal may include RSs for an event-triggered, UE-initiated CSI feedback request.

In some aspects, the UE 120 may learn or generate ABF beam weights using existing tracking reference signals (TRSs). In such aspects, the ABF information may include a recommended TRS periodicity to accommodate the ABF weight generation for FR1 or FR3 communications. UE recommendation of TRS periodicity may increase a coverage benefit afforded by the ABF beam weight learning procedure because ABF beam weights may be learned or generated based on coherence time conditions observed by the UE 120. For example, a lower (e.g., more frequent, less time between instances) periodicity may be applied to high Doppler conditions, or a higher periodicity (e.g., less frequent, more time between instances) may be applied to low Doppler conditions, leading to flexible tradeoffs between overhead and performance when implementing ABF beam weight learning.

Performance with ABF may improve as the delay spread of the channel decreases. For example, a channel between the UE 120 and the network node 110 may become frequency non-selective and a single set of ABF beam weights may be sufficient for an entire resource block allocation, which may cause improved ABF performance (e.g., more coverage for less resource expenditure). To achieve these benefits, the UE may estimate a delay spread for dynamic channel conditions between the UE 120 and the network node 110. The UE 120 may indicate when an ABF feature (and associated signaling, as described herein) may be activated (e.g., turned on) according to the estimate. For example, the delay spread may be a trigger condition for performing ABF beam weight learning.

As shown by reference number 915, the network node 110 may transmit one or more RS(s) to the UE 120 according to the RS configuration.

As shown by reference number 920, the UE 120 may generate ABF weights based on receiving the one or more RSs (e.g., CSI-RS, DMRSs, TRSs).

As shown by reference number 925, the network node 110 may transmit, and the UE 120 may receive, DL communications according to the ABF weights generated or learned described in connection with reference number 920.

As shown by reference number 930, the UE 120 may transmit, and the network node 110 may receive, UL communications according to the ABF weights generated or learned described in connection with reference number 920.

As indicated above, FIG. 9 is provided as an example. Other examples may differ from what is described with respect to FIG. 9.

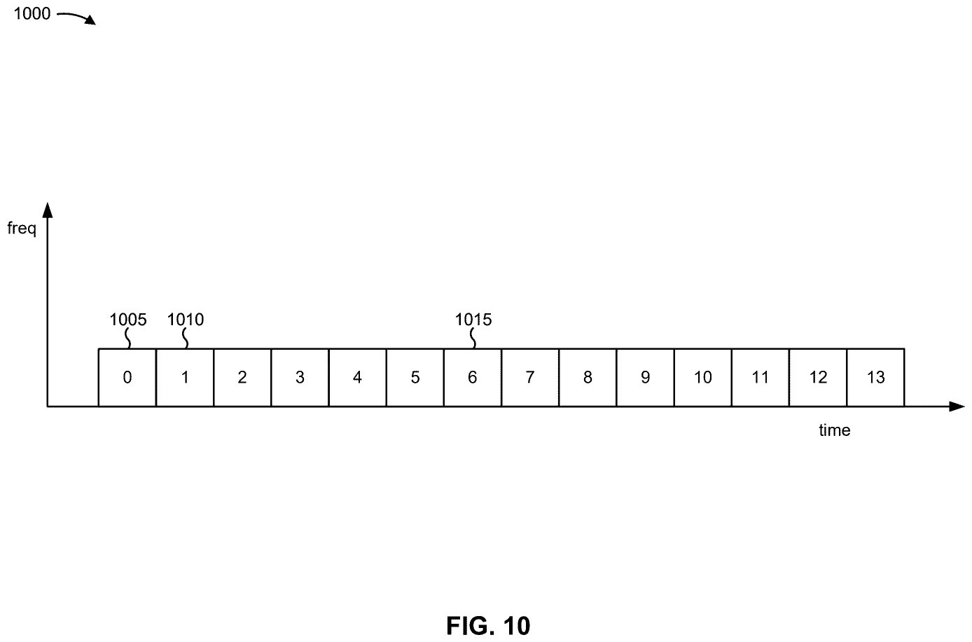

FIG. 10 is a diagram illustrating an example 1000 of a resource configuration.

The example 1000 may include at least a first granted reference signal symbol 1005, a second granted reference signal symbol 1010, and a data channel symbol 1015.

The quantity of the granted reference signals 1005 and 1010 may depend on a dynamic UE capability, such as how many RF chains are expected or configured to be active when receiving the quantity of the granted reference signals 1005 and 1010.

For example, if the UE includes 8 antenna elements with 4 receive antennas turned on, then the quantity of the granted reference signals 1005 and 1010 may include two reference signals. Additionally or alternatively, the UE may indicate a recommendation for multiple PDSCH transmissions where the UE learns the ABF beam weights from the DMRSs of a preceding PDSCH for use with a subsequent PDSCH, as described in connection with reference number 840 of FIG. 8 and reference number 910 of FIG. 9.

In the example 1000, the time gap described in connection with FIGS. 8 and 9, and communicated, in some aspects, as part of the ABF information, may include the quantity of resource blocks starting with, and including, a first reference signal measurement, a granted reference signal 1005, and the data channel symbol 1015. In such aspects, the time gap may indicate a duration of time associated with 7 resource blocks. In some aspects, the time gap of example 1000 may include the quantity of resource blocks starting with, and not including, a first reference signal measurement, the granted reference signal 1005, and the data channel symbol 1015. In such aspects, the time gap may indicate a duration of time associated with 5 resource blocks. In some aspects, the time gap of example 1000 may include the quantity of resource blocks starting with, and including, a last reference signal measurement, a granted reference signal 1010, and the data channel symbol 1015. In such aspects, the time gap may indicate a duration of time associated with 6 resource blocks. In some aspects, the time gap of example 1000 may include the quantity of resource blocks starting with, and not including, a last reference signal measurement, a granted reference signal 1010, and the data channel symbol 1015. In such aspects, the time gap may indicate a duration of time associated with 4 resource blocks. The indicated time gap may be defined according to one or more wireless communications standards, according to UE implementation, according to UE capability, or a combination thereof.

As indicated above, FIG. 10 is provided as an example. Other examples may differ from what is described with respect to FIG. 10.

FIG. 11 is a diagram illustrating an example process 1100 performed, for example, at a UE or an apparatus of a UE. Example process 1100 is an example where the apparatus or the UE (e.g., UE 120) performs operations associated with ABF beam weight learning with discrete antennas.

As shown in FIG. 11, in some aspects, process 1100 may include communicating, with a network node, information associated with an ABF procedure for generating one or more sets of ABF weights for communications via a frequency range using a set of monopole antennas (block 1110). For example, the UE (e.g., using reception component 1302, transmission component 1304, or communication manager 1306, depicted in FIG. 13) may communicate, with a network node, information associated with an ABF procedure for generating one or more sets of ABF weights for communications via a frequency range using a set of monopole antennas, as described above.

As further shown in FIG. 11, in some aspects, process 1100 may include generating the one or more sets of ABF weights in accordance with communicating the information associated with the ABF procedure (block 1120). For example, the UE (e.g., using communication manager 1306, depicted in FIG. 13) may generate the one or more sets of ABF weights in accordance with communicating the information associated with the ABF procedure, as described above.

As further shown in FIG. 11, in some aspects, process 1100 may include communicating, with the network node via the frequency range using the set of monopole antennas, one or more messages according to the one or more sets of ABF weights (block 1130). For example, the UE (e.g., using reception component 1302, transmission component 1304, or communication manager 1306, depicted in FIG. 13) may communicate, with the network node via the frequency range using the set of monopole antennas, one or more messages according to the one or more sets of ABF weights, as described above.

Process 1100 may include additional aspects, such as any single aspect or any combination of aspects described below or in connection with one or more other processes described elsewhere herein.

In a first aspect, process 1100 includes receiving, from the network node, one or more reference signals for measuring a wireless communications channel between the UE and the network node, and measuring the one or more reference signals to obtain one or more channel measurements associated with the wireless communications channel.

In a second aspect, alone or in combination with the first aspect, communicating the information associated with the ABF procedure comprises transmitting a time duration indication that indicates a duration of time between measuring a wireless communications channel between the UE and the network node and generating the one or more sets of ABF weights.

In a third aspect, alone or in combination with one or more of the first and second aspects, the duration of time includes a quantity of time resources between at least one of a first channel measurement or a last channel measurement, and a time resource during which the one or more sets of ABF weights are generated.

In a fourth aspect, alone or in combination with one or more of the first through third aspects, the duration of time is associated with at least one of a hardware capability or a radio frequency (RF) capability of the UE.

In a fifth aspect, alone or in combination with one or more of the first through fourth aspects, the time duration indication is associated with the frequency range of the communications.

In a sixth aspect, alone or in combination with one or more of the first through fifth aspects, communicating the information associated with the ABF procedure comprises transmitting a capability indication that indicates a duration of time in which the UE is capable of generating the one or more sets of ABF weights.

In a seventh aspect, alone or in combination with one or more of the first through sixth aspects, communicating the information associated with the ABF procedure comprises transmitting a time duration indication associated with generating the one or more sets of ABF weights, and process 1100 includes refraining from communicating with the network node during a duration of time indicated by the time duration indication.

In an eighth aspect, alone or in combination with one or more of the first through seventh aspects, process 1100 includes receiving, from the network node, a reference signal configuration that indicates a set of one or more granted reference signals, a quantity of granted reference signals, or both.

In a ninth aspect, alone or in combination with one or more of the first through eighth aspects, the quantity of granted reference signals is associated with a capability of the UE.

In a tenth aspect, alone or in combination with one or more of the first through ninth aspects, the quantity of granted reference signals is associated with a quantity of active receive antenna chains in a set of active receive antenna chains associated with the UE, and a quantity of antenna elements, associated with the set of active receive antenna chains, that are combined to form one or more virtual modules.

In an eleventh aspect, alone or in combination with one or more of the first through tenth aspects, the set of one or more granted reference signals includes at least one of a set of one or more channel state information reference signals (CSI-RSs), or a set of one or more demodulation reference signals (DMRSs).

In a twelfth aspect, alone or in combination with one or more of the first through eleventh aspects, the reference signal configuration indicates one or more time-frequency resources for communicating the set of one or more granted reference signals.

In a thirteenth aspect, alone or in combination with one or more of the first through twelfth aspects, the set of one or more granted reference signals includes one or more front-loaded reference signals that are associated with a downlink control channel.

In a fourteenth aspect, alone or in combination with one or more of the first through thirteenth aspects, process 1100 includes communicating, via a set of one or more frequency resources allocated to the UE, each reference signal indicated by the reference signal configuration independently from other communications via the set of one or more frequency resources allocated to the UE.

In a fifteenth aspect, alone or in combination with one or more of the first through fourteenth aspects, process 1100 includes transmitting an indication of one or more subsequent messages to be communicated using the one or more sets of ABF weights.

In a sixteenth aspect, alone or in combination with one or more of the first through fifteenth aspects, process 1100 includes communicating the one or more subsequent messages according to the one or more sets of ABF weights, in accordance with the indication of the one or more subsequent messages.

In a seventeenth aspect, alone or in combination with one or more of the first through sixteenth aspects, process 1100 includes receiving, from the network node, a reference signal configuration that indicates at least one of a first type of reference signal, or a second type of reference signal.

In an eighteenth aspect, alone or in combination with one or more of the first through seventeenth aspects, the first type of reference signal includes a reference signal that is independent of a time offset associated with generating the one or more sets of ABF weights.

In a nineteenth aspect, alone or in combination with one or more of the first through eighteenth aspects, the second type of reference signal includes a reference signal that is associated with generating the one or more sets of ABF weights.

In a twentieth aspect, alone or in combination with one or more of the first through nineteenth aspects, process 1100 includes transmitting, to the network node, a channel feedback request associated with a trigger condition being satisfied, and receiving a reference signal indication indicating a reference signal type associated with the ABF procedure.

In a twenty-first aspect, alone or in combination with one or more of the first through twentieth aspects, process 1100 includes receiving a set of one or more tracking reference signals, wherein generating the one or more sets of ABF weights is associated with receiving the set of one or more tracking reference signals.

In a twenty-second aspect, alone or in combination with one or more of the first through twenty-first aspects, process 1100 includes transmitting, to the network node, an indication of a reference signal periodicity for generating the one or more sets of ABF weights.

In a twenty-third aspect, alone or in combination with one or more of the first through twenty-second aspects, the reference signal periodicity is associated with one or more channel conditions.

In a twenty-fourth aspect, alone or in combination with one or more of the first through twenty-third aspects, process 1100 includes estimating a delay spread associated with a channel between the UE and the network node, and transmitting an indication of a time associated with triggering an ABF procedure that includes generating the one or more sets of ABF weights.

In a twenty-fifth aspect, alone or in combination with one or more of the first through twenty-fourth aspects, the frequency range includes at least one of a Frequency Range 1 (FR1), a Frequency Range 2 (FR2), or a Frequency Range 3 (FR3).

In a twenty-sixth aspect, alone or in combination with one or more of the first through twenty-fifth aspects, the set of monopole antennas includes one or more of a set of planar inverted F antennas, a set of omni-directional monopole antennas, a set of quasi-omnidirectional monopole antennas, a set of discrete antennas.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with ABF beam weight learning with discrete antennas.

As shown in FIG. 12, in some aspects, process 1200 may include communicating, with a UE that is using a set of monopole antennas, information associated with an ABF procedure for generating one or more sets of ABF weights to be used for communications via a frequency range associated with the set of monopole antennas (block 1210). For example, the network node (e.g., using reception component 1402, transmission component 1404, or communication manager 1406, depicted in FIG. 14) may communicate, with a UE that is using a set of monopole antennas, information associated with an ABF procedure for generating one or more sets of ABF weights to be used for communications via a frequency range associated with the set of monopole antennas, as described above.

As further shown in FIG. 12, in some aspects, process 1200 may include communicating, with the UE via the frequency range, one or more messages in accordance with the ABF procedure (block 1220). For example, the network node (e.g., using reception component 1402, transmission component 1404, or communication manager 1406, depicted in FIG. 14) may communicate, with the UE via the frequency range, one or more messages in accordance with the ABF procedure, as described above.

Process 1200 may include additional aspects, such as any single aspect or any combination of aspects described below or in connection with one or more other processes described elsewhere herein.

In a first aspect, process 1200 includes transmitting, to the UE, one or more reference signals for measuring a wireless communications channel between the UE and the network node, and measuring the one or more reference signals to obtain one or more channel measurements associated with the wireless communications channel.

In a second aspect, alone or in combination with the first aspect, communicating the information associated with the ABF procedure comprises receiving a time duration indication that indicates a duration of time between the UE performing a channel measurement procedure and the UE generating the one or more sets of ABF weights as part of the ABF procedure.

In a third aspect, alone or in combination with one or more of the first and second aspects, the duration of time includes a quantity of time resources between at least one of a first channel measurement or a last channel measurement, and a time resource during which the one or more sets of ABF weights are generated.

In a fourth aspect, alone or in combination with one or more of the first through third aspects, the duration of time is associated with at least one of a hardware capability or an RF capability of the UE.

In a fifth aspect, alone or in combination with one or more of the first through fourth aspects, the time duration indication is associated with the frequency range of the communications.

In a sixth aspect, alone or in combination with one or more of the first through fifth aspects, communicating the information associated with the ABF procedure comprises receiving a capability indication that indicates a duration of time in which the UE is capable of generating the one or more sets of ABF weights.

In a seventh aspect, alone or in combination with one or more of the first through sixth aspects, communicating the information associated with the ABF procedure comprises receiving a time duration indication associated with the ABF procedure, and process 1200 includes refraining from transmitting, to the UE during a duration of time indicated by the time duration indication, a resource grant in association with receiving the time duration indication.

In an eighth aspect, alone or in combination with one or more of the first through seventh aspects, process 1200 includes transmitting, to the UE, a reference signal configuration that indicates a set of one or more granted reference signals, a quantity of granted reference signals, or both.

In a ninth aspect, alone or in combination with one or more of the first through eighth aspects, the quantity of granted reference signals is associated with a capability of the UE.

In a tenth aspect, alone or in combination with one or more of the first through ninth aspects, the quantity of granted reference signals is associated with a quantity of active receive antenna chains in a set of active receive antenna chains associated with the UE, and a quantity of antenna elements, associated with the set of active receive antenna chains, that are combined to form one or more virtual modules.

In an eleventh aspect, alone or in combination with one or more of the first through tenth aspects, the set of one or more granted reference signals includes at least one of a set of one or more CSI-RSs, or a set of one or more DMRSs.

In a twelfth aspect, alone or in combination with one or more of the first through eleventh aspects, the reference signal configuration indicates one or more time-frequency resources for communicating the set of one or more granted reference signals.

In a thirteenth aspect, alone or in combination with one or more of the first through twelfth aspects, the set of one or more granted reference signals includes one or more front-loaded reference signals that are associated with a downlink control channel.

In a fourteenth aspect, alone or in combination with one or more of the first through thirteenth aspects, process 1200 includes communicating, via a set of one or more frequency resources allocated to the UE, each reference signal indicated by the reference signal configuration independently from other communications via the set of one or more frequency resources allocated to the UE.

In a fifteenth aspect, alone or in combination with one or more of the first through fourteenth aspects, process 1200 includes receiving an indication of one or more subsequent messages to be communicated as part of the ABF procedure.

In a sixteenth aspect, alone or in combination with one or more of the first through fifteenth aspects, process 1200 includes communicating the one or more subsequent messages according to the one or more sets of ABF weights, in accordance with the indication of the plurality of one or more messages.

In a seventeenth aspect, alone or in combination with one or more of the first through sixteenth aspects, process 1200 includes transmitting, to the UE, a reference signal configuration that indicates at least one of a first type of reference signal, or a second type of reference signal.

In an eighteenth aspect, alone or in combination with one or more of the first through seventeenth aspects, the first type of reference signal includes a reference signal that is independent of a time offset associated with the ABF procedure.

In a nineteenth aspect, alone or in combination with one or more of the first through eighteenth aspects, the second type of reference signal includes a reference signal that is associated with the ABF procedure.

In a twentieth aspect, alone or in combination with one or more of the first through nineteenth aspects, process 1200 includes receiving, from the UE, a channel feedback request associated with a trigger condition being satisfied, and transmitting a reference signal indication indicating a reference signal type associated with the ABF procedure.

In a twenty-first aspect, alone or in combination with one or more of the first through twentieth aspects, process 1200 includes transmitting a set of one or more tracking reference signals, wherein the ABF procedure is associated with the set of one or more tracking reference signals.

In a twenty-second aspect, alone or in combination with one or more of the first through twenty-first aspects, process 1200 includes receiving, from the UE, an indication of a reference signal periodicity for the ABF procedure.

In a twenty-third aspect, alone or in combination with one or more of the first through twenty-second aspects, the reference signal periodicity is associated with one or more channel conditions.

In a twenty-fourth aspect, alone or in combination with one or more of the first through twenty-third aspects, process 1200 includes receiving an indication of a time associated with triggering the ABF procedure in association with a delay spread associated with a channel between the UE and the network node.

In a twenty-fifth aspect, alone or in combination with one or more of the first through twenty-fourth aspects, the frequency range includes at least one of FR1, FR2, or FR3.

In a twenty-sixth aspect, alone or in combination with one or more of the first through twenty-fifth aspects, the set of monopole antennas includes one or more of a set of planar inverted F antennas, a set of omni-directional monopole antennas, a set of quasi-omnidirectional monopole antennas, a set of discrete antennas.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 8-10. Additionally, or alternatively, the apparatus 1300 may be configured to perform one or more processes described herein, such as process 1100 of FIG. 11, or a combination thereof. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 or the transmission component 1304 may communicate, with a network node, information associated with an ABF procedure for generating one or more sets of ABF weights for communications via a frequency range using a set of monopole antennas. The communication manager 1306 may generate the one or more sets of ABF weights in accordance with communicating the information associated with the ABF procedure. The reception component 1302 or the transmission component 1304 may communicate, with the network node via the frequency range using the set of monopole antennas, one or more messages according to the one or more sets of ABF weights.

The reception component 1302 may receive, from the network node, one or more reference signals for measuring a wireless communications channel between the UE and the network node.

The communication manager 1306 may measure the one or more reference signals to obtain one or more channel measurements associated with the wireless communications channel.

The reception component 1302 may receive, from the network node, a reference signal configuration that indicates a set of one or more granted reference signals, a quantity of granted reference signals, or both.

The communication manager 1306 may communicate, via a set of one or more frequency resources allocated to the UE, each reference signal indicated by the reference signal configuration independently from other communications via the set of one or more frequency resources allocated to the UE.

The transmission component 1304 may transmit an indication of one or more subsequent messages to be communicated using the one or more sets of ABF weights.

The communication manager 1306 may communicate the one or more subsequent messages according to the one or more sets of ABF weights, in accordance with the indication of the one or more subsequent messages.

The reception component 1302 may receive, from the network node, a reference signal configuration that indicates at least one of a first type of reference signal, or a second type of reference signal.

The transmission component 1304 may transmit, to the network node, a channel feedback request associated with a trigger condition being satisfied.

The reception component 1302 may receive a reference signal indication indicating a reference signal type associated with the ABF procedure.

The reception component 1302 may receive a set of one or more tracking reference signals, wherein generating the one or more sets of ABF weights is associated with receiving the set of one or more tracking reference signals.

The transmission component 1304 may transmit, to the network node, an indication of a reference signal periodicity for generating the one or more sets of ABF weights.

The communication manager 1306 may estimate a delay spread associated with a channel between the UE and the network node.

The transmission component 1304 may transmit an indication of a time associated with triggering an ABF procedure that includes generating the one or more sets of ABF weights.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 8-10. Additionally, or alternatively, the apparatus 1400 may be configured to perform one or more processes described herein, such as process 1200 of FIG. 12, or a combination thereof. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 or the transmission component 1404 may communicate, with a UE that is using a set of monopole antennas, information associated with an ABF procedure for generating one or more sets of ABF weights to be used for communications via a frequency range associated with the set of monopole antennas. The reception component 1402 or the transmission component 1404 may communicate, with the UE via the frequency range, one or more messages in accordance with the ABF procedure.

The transmission component 1404 may transmit, to the UE, one or more reference signals for measuring a wireless communications channel between the UE and the network node.

The communication manager 1406 may measure the one or more reference signals to obtain one or more channel measurements associated with the wireless communications channel.

The transmission component 1404 may transmit, to the UE, a reference signal configuration that indicates a set of one or more granted reference signals, a quantity of granted reference signals, or both.

The communication manager 1406 may communicate, via a set of one or more frequency resources allocated to the UE, each reference signal indicated by the reference signal configuration independently from other communications via the set of one or more frequency resources allocated to the UE.

The reception component 1402 may receive an indication of one or more subsequent messages to be communicated as part of the ABF procedure.

The communication manager 1406 may communicate the one or more subsequent messages according to the one or more sets of ABF weights, in accordance with the indication of the plurality of one or more messages.

The transmission component 1404 may transmit, to the UE, a reference signal configuration that indicates at least one of a first type of reference signal, or a second type of reference signal.

The reception component 1402 may receive, from the UE, a channel feedback request associated with a trigger condition being satisfied.

The transmission component 1404 may transmit a reference signal indication indicating a reference signal type associated with the ABF procedure.

The transmission component 1404 may transmit a set of one or more tracking reference signals, wherein the ABF procedure is associated with the set of one or more tracking reference signals.

The reception component 1402 may receive, from the UE, an indication of a reference signal periodicity for the ABF procedure.

The reception component 1402 may receive an indication of a time associated with triggering the ABF procedure in association with a delay spread associated with a channel between the UE and the network node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communications performed by a UE, comprising: communicating, with a network node, information associated with an analog beamforming procedure for generating one or more sets of analog beamforming weights for communications via a frequency range using a set of monopole antennas; generating the one or more sets of analog beamforming weights in accordance with communicating the information associated with the analog beamforming procedure; and communicating, with the network node via the frequency range using the set of monopole antennas, one or more messages according to the one or more sets of analog beamforming weights.
Aspect 2: The method of Aspect 1, further comprising: receiving, from the network node, one or more reference signals for measuring a wireless communications channel between the UE and the network node; and measuring the one or more reference signals to obtain one or more channel measurements associated with the wireless communications channel.
Aspect 3: The method of any of Aspects 1-2, wherein communicating the information associated with the analog beamforming procedure comprises: transmitting a time duration indication that indicates a duration of time between measuring a wireless communications channel between the UE and the network node and generating the one or more sets of analog beamforming weights.
Aspect 4: The method of Aspect 3, wherein the duration of time includes a quantity of time resources between at least one of a first channel measurement or a last channel measurement, and a time resource during which the one or more sets of analog beamforming weights are generated.
Aspect 5: The method of any of Aspects 3-4, wherein the duration of time is associated with at least one of a hardware capability or a radio frequency (RF) capability of the UE.
Aspect 6: The method of any of Aspects 3-5, wherein the time duration indication is associated with the frequency range of the communications.
Aspect 7: The method of any of Aspects 1-6, wherein communicating the information associated with the analog beamforming procedure comprises: transmitting a capability indication that indicates a duration of time in which the UE is capable of generating the one or more sets of analog beamforming weights.
Aspect 8: The method of any of Aspects 1-7, wherein communicating the information associated with the analog beamforming procedure comprises: transmitting a time duration indication associated with generating the one or more sets of analog beamforming weights, the method further comprising: refraining from communicating with the network node during a duration of time indicated by the time duration indication.
Aspect 9: The method of any of Aspects 1-8, further comprising: receiving, from the network node, a reference signal configuration that indicates a set of one or more granted reference signals, a quantity of granted reference signals, or both.
Aspect 10: The method of Aspect 9, wherein the quantity of granted reference signals is associated with a capability of the UE.
Aspect 11: The method of any of Aspects 9-10, wherein the quantity of granted reference signals is associated with: a quantity of active receive antenna chains in a set of active receive antenna chains associated with the UE, and a quantity of antenna elements, associated with the set of active receive antenna chains, that are combined to form one or more virtual modules.
Aspect 12: The method of any of Aspects 9-11, wherein the set of one or more granted reference signals includes at least one of: a set of one or more channel state information reference signals (CSI-RSs), or a set of one or more demodulation reference signals (DMRSs).
Aspect 13: The method of any of Aspects 9-12, wherein the reference signal configuration indicates one or more time-frequency resources for communicating the set of one or more granted reference signals.
Aspect 14: The method of any of Aspects 9-13, wherein the set of one or more granted reference signals includes one or more front-loaded reference signals that are associated with a downlink control channel.
Aspect 15: The method of any of Aspects 9-14, further comprising: communicating, via a set of one or more frequency resources allocated to the UE, each reference signal indicated by the reference signal configuration independently from other communications via the set of one or more frequency resources allocated to the UE.
Aspect 16: The method of any of Aspects 1-15, further comprising: transmitting an indication of one or more subsequent messages to be communicated using the one or more sets of analog beamforming weights.
Aspect 17: The method of Aspect 16, further comprising: communicating the one or more subsequent messages according to the one or more sets of analog beamforming weights, in accordance with the indication of the one or more subsequent messages.
Aspect 18: The method of any of Aspects 1-17, further comprising: receiving, from the network node, a reference signal configuration that indicates at least one of a first type of reference signal, or a second type of reference signal.
Aspect 19: The method of Aspect 18, wherein the first type of reference signal includes a reference signal that is independent of a time offset associated with generating the one or more sets of analog beamforming weights.
Aspect 20: The method of any of Aspects 18-19, wherein the second type of reference signal includes a reference signal that is associated with generating the one or more sets of analog beamforming weights.
Aspect 21: The method of any of Aspects 1-20, further comprising: transmitting, to the network node, a channel feedback request associated with a trigger condition being satisfied; and receiving a reference signal indication indicating a reference signal type associated with the analog beamforming procedure.
Aspect 22: The method of any of Aspects 1-21, further comprising: receiving a set of one or more tracking reference signals, wherein generating the one or more sets of analog beamforming weights is associated with receiving the set of one or more tracking reference signals.
Aspect 23: The method of any of Aspects 1-22, further comprising: transmitting, to the network node, an indication of a reference signal periodicity for generating the one or more sets of analog beamforming weights.
Aspect 24: The method of Aspect 23, wherein the reference signal periodicity is associated with one or more channel conditions.
Aspect 25: The method of any of Aspects 1-24, further comprising: estimating a delay spread associated with a channel between the UE and the network node; and transmitting an indication of a time associated with triggering an analog beamforming procedure that includes generating the one or more sets of analog beamforming weights.
Aspect 26: The method of any of Aspects 1-25, wherein the frequency range includes at least one of a Frequency Range 1 (FR1), a Frequency Range 2 (FR2), or a Frequency Range 3 (FR3).
Aspect 27: The method of any of Aspects 1-26, wherein the set of monopole antennas includes one or more of: a set of planar inverted F antennas, a set of omni-directional monopole antennas, a set of quasi-omnidirectional monopole antennas, a set of discrete antennas.
Aspect 28: A method of wireless communication performed by a network node, comprising: communicating, with a user equipment (UE) that is using a set of monopole antennas, information associated with an analog beamforming procedure for generating one or more sets of analog beamforming weights to be used for communications via a frequency range associated with the set of monopole antennas; and communicating, with the UE via the frequency range, one or more messages in accordance with the analog beamforming procedure.
Aspect 29: The method of Aspect 28, further comprising: transmitting, to the UE, one or more reference signals for measuring a wireless communications channel between the UE and the network node; and measuring the one or more reference signals to obtain one or more channel measurements associated with the wireless communications channel.
Aspect 30: The method of any of Aspects 28-29, wherein communicating the information associated with the analog beamforming procedure comprises: receiving a time duration indication that indicates a duration of time between the UE performing a channel measurement procedure and the UE generating the one or more sets of analog beamforming weights as part of the analog beamforming procedure.
Aspect 31: The method of Aspect 30, wherein the duration of time includes a quantity of time resources between at least one of a first channel measurement or a last channel measurement, and a time resource during which the one or more sets of analog beamforming weights are generated.
Aspect 32: The method of any of Aspects 30-31, wherein the duration of time is associated with at least one of a hardware capability or a radio frequency (RF) capability of the UE.
Aspect 33: The method of any of Aspects 30-32, wherein the time duration indication is associated with the frequency range of the communications.
Aspect 34: The method of any of Aspects 28-33, wherein communicating the information associated with the analog beamforming procedure comprises: receiving a capability indication that indicates a duration of time in which the UE is capable of generating the one or more sets of analog beamforming weights.
Aspect 35: The method of any of Aspects 28-34, wherein communicating the information associated with the analog beamforming procedure comprises: receiving a time duration indication associated with the analog beamforming procedure, the method further comprising: refraining from transmitting, to the UE during a duration of time indicated by the time duration indication, a resource grant in association with receiving the time duration indication.
Aspect 36: The method of any of Aspects 28-35, further comprising: transmitting, to the UE, a reference signal configuration that indicates a set of one or more granted reference signals, a quantity of granted reference signals, or both.
Aspect 37: The method of Aspect 36, wherein the quantity of granted reference signals is associated with a capability of the UE.
Aspect 38: The method of any of Aspects 36-37, wherein the quantity of granted reference signals is associated with: a quantity of active receive antenna chains in a set of active receive antenna chains associated with the UE, and a quantity of antenna elements, associated with the set of active receive antenna chains, that are combined to form one or more virtual modules.
Aspect 39: The method of any of Aspects 36-38, wherein the set of one or more granted reference signals includes at least one of: a set of one or more channel state information reference signals (CSI-RSs), or a set of one or more demodulation reference signals (DMRSs).
Aspect 40: The method of any of Aspects 36-39, wherein the reference signal configuration indicates one or more time-frequency resources for communicating the set of one or more granted reference signals.
Aspect 41: The method of any of Aspects 36-40, wherein the set of one or more granted reference signals includes one or more front-loaded reference signals that are associated with a downlink control channel.
Aspect 42: The method of any of Aspects 36-41, further comprising: communicating, via a set of one or more frequency resources allocated to the UE, each reference signal indicated by the reference signal configuration independently from other communications via the set of one or more frequency resources allocated to the UE.
Aspect 43: The method of any of Aspects 28-42, further comprising: receiving an indication of one or more subsequent messages to be communicated as part of the analog beamforming procedure.
Aspect 44: The method of Aspect 43, further comprising: communicating the one or more subsequent messages according to the one or more sets of analog beamforming weights, in accordance with the indication of the plurality of one or more messages.
Aspect 45: The method of any of Aspects 28-44, further comprising: transmitting, to the UE, a reference signal configuration that indicates at least one of a first type of reference signal, or a second type of reference signal.
Aspect 46: The method of Aspect 45, wherein the first type of reference signal includes a reference signal that is independent of a time offset associated with the analog beamforming procedure.
Aspect 47: The method of any of Aspects 45-46, wherein the second type of reference signal includes a reference signal that is associated with the analog beamforming procedure.
Aspect 48: The method of any of Aspects 28-47, further comprising: receiving, from the UE, a channel feedback request associated with a trigger condition being satisfied; and transmitting a reference signal indication indicating a reference signal type associated with the analog beamforming procedure.
Aspect 49: The method of any of Aspects 28-48, further comprising: transmitting a set of one or more tracking reference signals, wherein the analog beamforming procedure is associated with the set of one or more tracking reference signals.
Aspect 50: The method of any of Aspects 28-49, further comprising: receiving, from the UE, an indication of a reference signal periodicity for the analog beamforming procedure.
Aspect 51: The method of Aspect 50, wherein the reference signal periodicity is associated with one or more channel conditions.
Aspect 52: The method of any of Aspects 28-51, further comprising: receiving an indication of a time associated with triggering the analog beamforming procedure in association with a delay spread associated with a channel between the UE and the network node.
Aspect 53: The method of any of Aspects 28-52, wherein the frequency range includes at least one of a Frequency Range 1 (FR1), a Frequency Range 2 (FR2), or a Frequency Range 3 (FR3).
Aspect 54: The method of any of Aspects 28-53, wherein the set of monopole antennas includes one or more of: a set of planar inverted F antennas, a set of omni-directional monopole antennas, a set of quasi-omnidirectional monopole antennas, a set of discrete antennas.
Aspect 55: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-54.
Aspect 56: An apparatus for wireless communication at a device, the apparatus comprising one or more memories and one or more processors coupled to the one or more memories, the one or more processors configured to cause the device to perform the method of one or more of Aspects 1-54.
Aspect 57: An apparatus for wireless communication, the apparatus comprising at least one means for performing the method of one or more of Aspects 1-54.
Aspect 58: A non-transitory computer-readable medium storing code for wireless communication, the code comprising instructions executable by one or more processors to perform the method of one or more of Aspects 1-54.
Aspect 59: A non-transitory computer-readable medium storing a set of instructions for wireless communication, the set of instructions comprising one or more instructions that, when executed by one or more processors of a device, cause the device to perform the method of one or more of Aspects 1-54.
Aspect 60: A device for wireless communication, the device comprising a processing system that includes one or more processors and one or more memories coupled with the one or more processors, the processing system configured to cause the device to perform the method of one or more of Aspects 1-54.
Aspect 61: An apparatus for wireless communication at a device, the apparatus comprising one or more memories and one or more processors coupled to the one or more memories, the one or more processors individually or collectively configured to cause the device to perform the method of one or more of Aspects 1-54.
Aspect 62: A device comprising a processing system that includes one or more processors and one or more code-storing memories coupled with the one or more processors, the processing system configured to cause the device to perform the method of one or more of Aspects 1-54.
Aspect 63: A device comprising a processing system that includes processor circuitry and code-storing memory circuitry, the processing system configured to cause the device to perform the method of one or more of Aspects 1-54.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communications performed by a user equipment (UE), comprising:
communicating, with a network node, information associated with an analog beamforming procedure for generating one or more sets of analog beamforming weights for communications via a frequency range using a set of monopole antennas;
generating the one or more sets of analog beamforming weights in accordance with communicating the information associated with the analog beamforming procedure; and
communicating, with the network node via the frequency range using the set of monopole antennas, one or more messages according to the one or more sets of analog beamforming weights.

2. The method of claim 1, further comprising:
receiving, from the network node, one or more reference signals for measuring a wireless communications channel between the UE and the network node; and
measuring the one or more reference signals to obtain one or more channel measurements associated with the wireless communications channel.

3. The method of claim 1, wherein communicating the information associated with the analog beamforming procedure comprises:
transmitting a time duration indication that indicates a duration of time between measuring a wireless communications channel between the UE and the network node and generating the one or more sets of analog beamforming weights.

4. The method of claim 3, wherein the duration of time includes a quantity of time resources between at least one of a first channel measurement or a last channel measurement, and a time resource during which the one or more sets of analog beamforming weights are generated.

5. The method of claim 3, wherein the duration of time is associated with at least one of a hardware capability or a radio frequency (RF) capability of the UE.

6. The method of claim 3, wherein the time duration indication is associated with the frequency range of the communications.

7. The method of claim 1, wherein communicating the information associated with the analog beamforming procedure comprises:
transmitting a capability indication that indicates a duration of time in which the UE is capable of generating the one or more sets of analog beamforming weights.

8. A user equipment (UE), comprising:
a processing system that includes one or more processors and one or more code-storing memories coupled with the one or more processors, the processing system configured to cause the UE to:
communicate, with a network node, information associated with an analog beamforming procedure for generating one or more sets of analog beamforming weights for communications via a frequency range using a set of monopole antennas;
generate the one or more sets of analog beamforming weights in accordance with communicating the information associated with the analog beamforming procedure; and
communicate, with the network node via the frequency range using the set of monopole antennas, one or more messages according to the one or more sets of analog beamforming weights.

9. The UE of claim 8, wherein the processing system, to cause the UE to communicate the information associated with the analog beamforming procedure, is configured to cause the UE to:
transmit a time duration indication associated with generating the one or more sets of analog beamforming weights, the processing system configured to cause the UE to:
refrain from communicating with the network node during a duration of time indicated by the time duration indication.

10. The UE of claim 8, wherein the processing system is configured to cause the UE to:
receive, from the network node, a reference signal configuration that indicates a set of one or more granted reference signals, a quantity of granted reference signals, or both.

11. The UE of claim 10, wherein the quantity of granted reference signals is associated with a capability of the UE.

12. The UE of claim 10, wherein the quantity of granted reference signals is associated with:
a quantity of active receive antenna chains in a set of active receive antenna chains associated with the UE, and
a quantity of antenna elements, associated with the set of active receive antenna chains, that are combined to form one or more virtual modules.

13. The UE of claim 10, wherein the set of one or more granted reference signals includes at least one of:
a set of one or more channel state information reference signals (CSI-RSs), or
a set of one or more demodulation reference signals (DMRSs).

14. The UE of claim 10, wherein the processing system is configured to cause the UE to:
communicate, via a set of one or more frequency resources allocated to the UE, each reference signal indicated by the reference signal configuration independently from other communications via the set of one or more frequency resources allocated to the UE.

15. An apparatus for wireless communication, comprising:
means for communicating, with a network node, information associated with an analog beamforming procedure for generating one or more sets of analog beamforming weights for communications via a frequency range using a set of monopole antennas;
means for generating the one or more sets of analog beamforming weights in accordance with communicating the information associated with the analog beamforming procedure; and
means for communicating, with the network node via the frequency range using the set of monopole antennas, one or more messages according to the one or more sets of analog beamforming weights.

16. The apparatus of claim 15, further comprising:
means for transmitting an indication of one or more subsequent messages to be communicated using the one or more sets of analog beamforming weights.

17. The apparatus of claim 15, further comprising:
means for receiving, from the network node, a reference signal configuration that indicates at least one of a first type of reference signal, or a second type of reference signal.

18. The apparatus of claim 15, further comprising:
means for transmitting, to the network node, a channel feedback request associated with a trigger condition being satisfied; and
means for receiving a reference signal indication indicating a reference signal type associated with the analog beamforming procedure.

19. The apparatus of claim 15, further comprising:
means for receiving a set of one or more tracking reference signals, wherein generating the one or more sets of analog beamforming weights is associated with receiving the set of one or more tracking reference signals.

20. The apparatus of claim 15, further comprising:
means for transmitting, to the network node, an indication of a reference signal periodicity for generating the one or more sets of analog beamforming weights.
